(19) United States
(12) Patent Application Publication
(10) Pub. No.: US 2020/0019305 A1
(43) Pub. Date: Jan. 16, 2020

(54) METHOD FOR ALTERING DISPLAY RATIO OF APPLICATION, AND ELECTRONIC DEVICE THAT REALISES SAME

(71) Applicant: Samsung Electronics Co., Ltd., Suwon-si, Gyeonggi-do (KR)

(72) Inventors: Jieun YANG, Seoul (KR); Jin Hee JEON, Seongnam-si (KR)

(21) Appl. No.: 16/497,265

(22) PCT Filed: Mar. 22, 2018
(86) PCT No.: PCT/KR2018/003296

§ 371 Date: Sep. 24, 2019

(30) Foreign Application Priority Data
Mar. 24, 2017 (KR) 10-2017-0037611

(51) Int. Cl. G06F 3/0488; G06F 3/0482; G06F 3/147; G06F 3/041

(52) U.S. Cl. CPC G06F 3/04883; G06F 3/0482; G06F 3/04886; G06F 3/0412; G06F 3/147

(57) ABSTRACT

Various embodiments provide a method and an apparatus that comprises a memory, a display and a processor that is functionally connected to the memory or the display, wherein the processor is configured, when a user input for selecting a menu item is detected while an execution screen of an application is displayed on the display, to confirm display ratio configuration information, stored in the memory, of the application, to display a button for altering a display ratio of the application onto an application card on a list of applications that have recently been executed based on the confirmed display ratio configuration information, and to alter a display ratio of the application according to a selection of the displayed button. In addition, other embodiments are possible.

### TECHNICAL FIELD

Various embodiments relate to a method and apparatus for altering a display ratio of an application.

### BACKGROUND ART

With the recent growth of digital technologies, various types of electronic devices are being widely used such as mobile communication terminals, personal digital assistants (PDAs), electronic organizers, smart phones, tablet personal computers (PCs), wearable devices, etc. These electronic devices are being continuously improved in hardware aspects and/or software aspects, for the sake of function support and enhancement.

The electronic device can be manufactured to have a specific screen ratio (below, a first screen ratio), for example, 16:9 or 4:3. Here, the screen ratio can refer to a ratio of vertical and horizontal sizes (lengths) of a display representing a display region of the electronic device. An application executed in the electronic device is being developed suitable to the first screen ratio of the electronic device.

### DISCLOSURE OF INVENTION

### Technical Problem

As described above, the conventional applications are being developed optimal to the first screen ratio of the electronic device, so there may be no need to alter a display ratio of each application in the electronic device.

On the other hand, in recent years, electronic devices having another screen ratio (below, a second screen ratio) (e.g., 18.5:9) are being developed. The electronic device having the second screen ratio as above may fail to suitably display, in full screen, an execution screen of the application developed optimal to the first screen ratio. For example, because the electronic device having the second screen ratio arbitrarily alters a display ratio of the execution screen of the application, a portion of the execution screen of the application can be cut out and unseen. Or, because the electronic device displays the execution screen of the application without altering the display ratio of the application, a dead space (e.g., a region displayed in black) can be generated on the execution screen of the application.

Various embodiments can provide a method and apparatus for efficiently and conveniently altering a display ratio of an application in an electronic device having a second screen ratio.

### Solution to Problem

An electronic device of various embodiments may include a memory, a display, and a processor operatively connected to the memory or the display. The processor may be configured to, in response to detecting a user input of selecting a menu item while an execution screen of an application is displayed on the display, confirm display ratio configuration information, stored in the memory, of the application, display a button for altering a display ratio of the application onto an application card on a list of recently executed applications, based on the confirmed display ratio configuration information, and alter the display ratio of the application according to a selection of the displayed button.

An operation method of an electronic device of various embodiments may include displaying an execution screen of an application, detecting a user input of selecting a menu item, confirming display ratio configuration information of the displayed application, displaying a button for altering a display ratio of the application onto an application card on a list of recently executed applications, based on the confirmed display ratio configuration information, and altering the display ratio of the application according to a selection of the displayed button.

A computer-readable recording medium of various embodiments may include a program for executing instructions, the instructions comprising displaying an execution screen of an application, detecting a user input of selecting a menu item, confirming display ratio configuration information of the displayed application, displaying a button for altering a display ratio of the application onto an application card on a list of recently executed applications, based on the confirmed display ratio configuration information, and altering the display ratio of the application according to a selection of the displayed button.

### Advantageous Effects of Invention

According to various embodiments, an electronic device may efficiently alter a display ratio of an application.

According to various embodiments, the electronic device may check whether a display ratio of an application is compatible with a screen ratio of the electronic device and, if they are not compatible, the electronic device may convert and display the execution screen of the application adaptively to the electronic device.

According to various embodiments, in response to a portion of the execution screen of the application not being displayed on a display of the electronic device, or a dead space being provided in the execution screen of the application, the electronic device may optimize and display a display ratio of the application suitably to a screen ratio of the electronic device.

According to various embodiments, by providing a user interface for configuring a display ratio of each application, the electronic device may alter the display ratio of the application even without executing the application.

### BRIEF DESCRIPTION OF DRAWINGS

FIG. 1 is a diagram illustrating a construction of an electronic device according to various embodiments.

FIG. 2 is a flowchart illustrating an operation method of an electronic device according to various embodiments.

FIG. 3 is a diagram illustrating an example of altering a display ratio of an application by the method of FIG. 2 according to various embodiments.

FIG. 4 is a flowchart illustrating a method for altering a display ratio of an application according to various embodiments.

FIG. 5 is a diagram illustrating an example of altering a display ratio of an application by the method of FIG. 4 according to various embodiments.

FIG. 6 is a flowchart illustrating a method for altering a display ratio of an application on the basis of a button according to various embodiments.

FIG. 7 is a diagram illustrating an example of altering a display ratio of an application by the method of FIG. 6 according to various embodiments.

FIG. 8 is a flowchart illustrating a method for altering a display ratio of an application on the basis of a gesture according to various embodiments.

FIG. 9 is a diagram illustrating an example of altering a display ratio of an application by the method of FIG. 8 according to various embodiments.

FIG. 10 is a diagram illustrating a method of determining button information for display ratio alteration according to various embodiments.

FIG. 11 is a diagram illustrating an example of showing display ratio information of each application according to various embodiments.

FIG. 12 is a flowchart illustrating an operation for altering a display ratio of each application in an electronic device according to various embodiments.

### BEST MODE FOR CARRYING OUT THE INVENTION

Various embodiments of the disclosure are mentioned below with reference to the accompanying drawings. However, these do not intend to limit a technology mentioned in the disclosure to a specific embodiment form, and should be understood as including various modifications, equivalents and/or alternatives of various embodiments of the disclosure. With regard to a description of the drawings, like reference numerals may be used to refer like components. And, an embodiment disclosed in the disclosure has been suggested for explanation and understanding of the technology disclosed, and does not limit the scope of the technology mentioned in the disclosure. Accordingly, the scope of the disclosure should be interpreted as including all changes or various other embodiments that are based on the technological spirit of the disclosure.

In an embodiment of the disclosure, the electronic device may include all devices which use one or more of various processors such as an application processor (AP), a communication processor (CP), a graphic processing unit (GPU), a central processing unit (CPU), etc., such as all information communication equipment, multimedia equipment, wearable devices, and applied equipment thereof which support a function (e.g., a display function) of various embodiments of the disclosure.

An electronic device of an embodiment of the disclosure may, for example, include at least one of a smart phone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), a moving picture experts group (MPEG-1 or MPEG-2) audio layer 3 (MP3) player, a mobile medical device, a camera, or a wearable device (e.g., smart glasses, a head-mounted-device (HMD), or a smart watch).

Also, in an embodiment of the disclosure, the electronic device may be a smart home appliance. The smart home appliance may, for example, include at least one of a television (TV), a digital video disk (DVD) player, a refrigerator, an air conditioner, a cleaner, a washing machine, a set-top box, a home automation control panel, a TV box (e.g., Samsung HomeSync™, Apple TV™, or Google TV™), a game console (e.g., Xbox™ and/or PlayStation™), or an electronic frame. Also, in an embodiment of the disclosure, the electronic device may include at least one of a navigation device or an internet of things (IoT).

In various embodiments, the electronic device may be a combination of one or more of the aforementioned various devices. The electronic device of some embodiment may be a flexible electronic device. Also, the electronic device of an embodiment of the disclosure is not limited to the aforementioned devices, and may include a new electronic device with technological advancement.

Also, in an embodiment of the disclosure, the term ‘user’ may denote a person who uses the electronic device or a device (e.g., an artificial-intelligent electronic device) which uses the electronic device. In an embodiment of the disclosure, the module or program module may include at least one of various constituent elements of the disclosure, or omit some elements, or further include additional another constituent element. Operations carried out by the module, the program module or the other constituent element of various embodiments may be executed in a sequential, parallel, repeated or heuristic method. Also, some operations may be executed in different order or be omitted, or other operations may be added.

Below, a method for altering a display ratio of an application of an embodiment of the disclosure and an electronic device thereof are described with reference to the accompanying drawings. However, it should be noted that the disclosure is applicable to various embodiments by way of an embodiment described below, in that a description made below does not limit or restrict various embodiments of the disclosure. In various embodiments of the disclosure described below, a hardware-based access method is described by way of example. However, various embodiments of the disclosure do not exclude a software-based access method in that various embodiments of the disclosure include a technology using all of hardware and software.

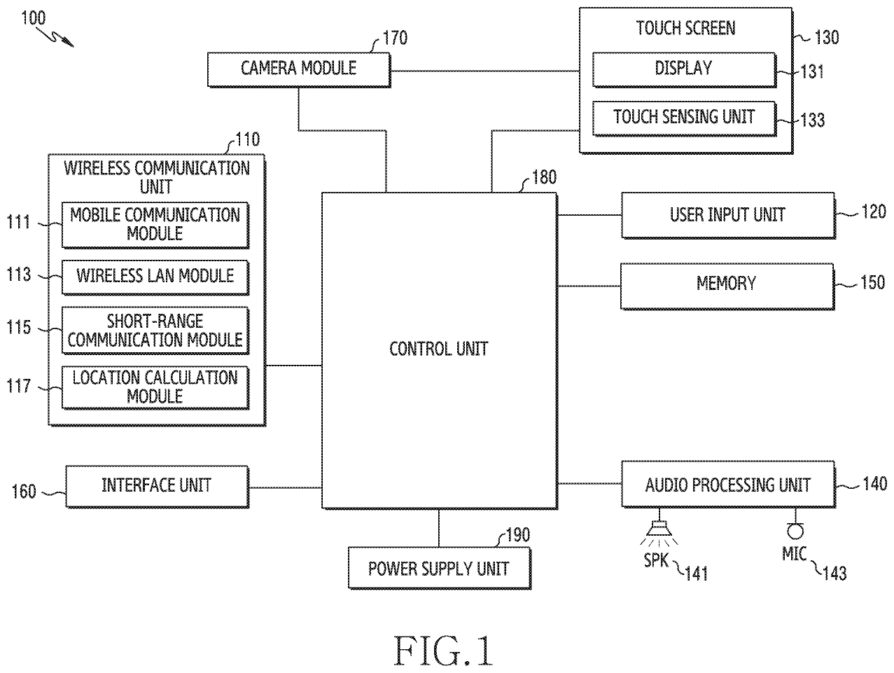

FIG. 1 is a diagram illustrating a construction of an electronic device according to various embodiments.

Referring to FIG. 1, the electronic device 100 of various embodiments of the disclosure may include a wireless communication unit 110, a user input unit 120, a touch screen 130, an audio processing unit 140, a memory 150, an interface unit 160, a camera module 170, a control unit 180, and a power supply unit 190. In various embodiments of the disclosure, the elements illustrated in FIG. 1 are not essential, so the electronic device 100 may be implemented to have elements more than the elements illustrated in FIG. 1 or have elements less than them.

The wireless communication unit 110 may include one or more modules enabling wireless communication between the electronic device 100 and another external electronic device. In various embodiments, the wireless communication unit 110 may include a module (e.g., a short-range communication module, a long-range communication module, etc.) for performing communication with a peripheral external electronic device. For example, the wireless communication unit 110 may include a mobile communication module 111, a wireless local area network (WLAN) module 113, a short-range communication module 115, a location calculation module 117 and the like.

The mobile communication module 111 may transmit and/or receive a wireless signal with at least one of a base station, an external electronic device, and various servers (e.g., an integration server, a provider server, a content server, an Internet server, or a cloud sever) on a mobile communication network. The wireless signal may include a voice signal, a data signal, or various types of control signals. In response to a user request, the mobile communication module 111 may transmit various data, which are necessary for an operation of the electronic device 100, to an external device (e.g., a server, another electronic device or the like). In various embodiments, the mobile communication module 111 may transmit and/or receive a wireless signal, based on various communication schemes. For example, the communication scheme may include, though not limited to, a communication scheme such as long-term evolution (LTE), LTE advance (LTE-A), global system for mobile communication (GSM), enhanced data GSM environment (EDGE), code division multiple access (CDMA), wideband CDMA (WCDMA), universal mobile telecommunications system (UMTS), orthogonal frequency division multiple access (OFDMA) or the like.

The wireless LAN module 113 may refer to a module for forming wireless Internet access and a wireless LAN link with another external electronic device. The wireless LAN module 113 may be built in or built outside the electronic device 100. A wireless Internet technology may be wireless fidelity (Wi-Fi), light fidelity (Life), wireless broadband (Wibro), world interoperability for microwave access (WiMax), millimeter wave (mmWave) (e.g., wireless gigabit alliance (WiGig)) or the like. The wireless LAN module 113 may interwork with another external electronic device coupled with the electronic device 100 through a network (e.g., a wireless internet network), to transmit various data of the electronic device 100 to the external (e.g., the external electronic device or the server), or receive from the external. The wireless LAN module 113 may maintain a full-time ON state, or turn-on according to the setting of the electronic device 100 or a user input.

The short-range communication module 115 may refer to a module for performing short-range communication. A short-range communication technology may be Bluetooth, Bluetooth low energy (BLE), radio frequency identification (RFID), infrared data association (IrDA), ultra wideband (UWB), ZigBee, near field communication (NFC) or the like. The short-range communication module 115 may interwork with another external electronic device (e.g., an external sound device) connected with the electronic device 100 through a network (e.g., a short-range communication network), to transmit various data of the electronic device 100 to the external electronic device or receive. The short-range communication module 115 may maintain a full-time ON state, or turn-on according to the setting of the electronic device 100 or a user input.

The location calculation module 117, a module for obtaining a location of the electronic device 100, may include a GPS module as a typical example. The location calculation module 117 may measure a location of the electronic device 100 by the principle of triangulation. For example, the location calculation module 117 may calculate three-dimension current location information of latitude, longitude and altitude, by calculating distance information distant from three or more base stations and time information and then applying a triangulation method to the calculated information. Or, the location calculation module 117 may calculate the location information, by keeping receiving location information of the electronic device 100 in real time from three or more satellites. The location information of the electronic device 100 may be obtained by various methods.

In response to a user input, the user input unit 120 may provide input data for control of an operation of the electronic device 100. The user input unit 120 may include at least one input means for providing user's various inputs. For example, the user input unit 120 may include a key pad, a dome switch, a physical button, a touchpad (resistive/capacitive), a jog shuttle, a sensor and the like. Part of the user input unit 120 may be implemented in a button form outside the electronic device 100, and part thereof or the whole may be implemented as a touch panel as well. The user input unit 120 may receive a user input for initiating an operation of the electronic device 100 of various embodiments of the disclosure, and may provide an input signal of the user input.

The touch screen 130 refers to an input/output device capable of simultaneously performing an input function and a display function, and may include a display 131 and a touch sensing unit 133. The touch screen 130 may provide an input/output interface between the electronic device 100 and a user, and may forward a user's touch input to the electronic device 100, and may include a medium role of showing the output of the electronic device 100 to the user. The touch screen 130 may show a visual output to the user. The visual output may be shown in the form of a text, a graphic, a video, and a combination of them. In an embodiment of the disclosure, the touch screen 130 may display various screens of an operation of the electronic device 100 through the display 131. While displaying a specific screen through the display 131, the touch screen 130 may sense an event (e.g., a touch event, a proximity event, a hovering event, and/or an air gesture event) that is based on at least one of a touch, hovering or an air gesture from the user through the touch sensing unit 133, and may forward an input signal of the event to the control unit 180.

According to various embodiments of the disclosure, the display 131 may display (output) a variety of information processed in the electronic device 100. For example, the display 131 may display a user interface (UI) or a graphic user interface (GUI) which is related with an operation of displaying an execution screen of an application, a button for altering a display ratio of the application, and an execution screen of an application whose display ratio is altered. The display 131 may support a screen display of a transverse mode, a screen display of a longitudinal mode, or a screen display being based on variation between the transverse mode and the longitudinal mode, according to a rotation direction (or a placed direction) of the electronic device 100. The display 131 may use various displays. In various embodiments, the display 131 may include a bended display, a rollable display or a flexible display which has a thin and flexible substrate.

The bended display may be combined to a housing (e.g., a main body), to keep a bent form. The rollable display may be rolled in a specific form (e.g., a cylinder) like paper. The flexible display may be free to be bent and unbent.

In various embodiments, the display 131 may provide flexibility making foldable and unfoldable, by replacing a plastic film for a glass substrate wrapping a liquid crystal in a liquid crystal display (LCD), a light emitting diode (LED) display, an organic LED (OLED) display, an active matrix OLED (AMOLED) display, an electronic paper or the like. In various embodiments, the display 131 may be extended and combined to at least one side (e.g., a surface of at least one of the left side, the right side, the top side, and the bottom side) of the electronic device 100.

The touch sensing unit 133 may be safely mounted in the display 131, and may sense a user input that gets in touch with or comes close to a surface of the touch screen 130. In an embodiment of the disclosure, the touch sensing unit 133 may receive a user input for initiating an operation related with use of the electronic device 100, and may provide an input signal of the user input. The user input may include a touch event or proximity event that is inputted based on at least one of a single-touch, a multi-touch, hovering or an air gesture. For example, the user input may be inputted in a scheme of tap, drag, sweep, swipe, flick, drag and drop, or a drawing gesture (e.g., handwriting, etc.).

The audio processing unit 140 may perform a function of transmitting an audio signal inputted from the control unit 180, to a speaker (SPK) 141, and forwarding an audio signal such as a voice, etc. inputted from a microphone (MIC) 143, to the control unit 180. Under the control of the control unit 180, the audio processing unit 140 may convert voice/sound data into an audible sound, to output through the speaker 141, and convert an audio signal such as a voice, etc. received from the microphone 143 into a digital signal, to forward to the control unit 180. The audio processing unit 140 may output an audio signal responding to a user input according to audio processing information (e.g., an effect sound, a music file, etc.) inserted into data.

The speaker 141 may output audio data that is received from the wireless communication unit 110 or is stored in the memory 150. The speaker 141 may output a sound signal related with various operations (functions) carried out by the electronic device 100 as well. Though not illustrated in an embodiment of the disclosure, the speaker 141 may comprise an attachable and detachable ear phone, head phone or head set connected to the electronic device 100 through an external port of the electronic device 100.

The microphone 143 may receive and process an external sound signal into electrical voice data. The microphone 143 may implement various noise reduction algorithms for removing a noise that is provided in a process of receiving an external sound signal. The microphone 143 may take charge of input of an audio stream such as a voice command (e.g., a voice command for initiating an operation of a music application), etc. The microphone 143 may include an internal microphone mounted in the electronic device 100 and an external microphone connected to the electronic device 100.

The memory 150 may store one or more programs executed by the control unit 180, and may perform a function for temporarily storing inputted/outputted data as well. The inputted/outputted data may, for example, include files of a video, an image, a photo, an audio, etc. The memory 150 may take charge of a role of storing obtained data. Data obtained in real time may be stored in a temporary storage device, and data confirmed to be stored may be stored in a long-preservable storage device.

In various embodiments, the memory 150 may store instructions configured to, at execution, enable the control unit 180 (e.g., one or more processors) to, in response to detecting a user input of selecting a menu item while an execution screen of an application is displayed on the display 131, confirm display ratio configuration information of the application stored in the memory 150, and display a button for altering a display ratio of the application, based on the confirmed display ratio configuration information, onto an application card on a list of recently executed applications, and alter the display ratio of the application according to a selection of the displayed button.

The memory 150 may continuously or temporarily store an operating system (OS) of the electronic device 100, a program related with input and display control using the touch screen 130, a program related with control of various operations (functions) of the electronic device 100, various data provided by operations of the respective programs, and the like.

The memory 150 may include an extended memory (e.g., an external memory) or an internal memory. The memory 150 may include a storage medium of at least one type among memories of a flash memory type, a hard disk type, a micro type, a card type (for instance, a secure digital (SD) card or an extreme digital (XD) card) and the like, and memories of a dynamic random access memory (DRAM) type, a static RAM (SRAM) type, a read-only memory (ROM) type, a programmable ROM (PROM) type, an electrically erasable PROM (EEPROM) type, a magnetic RAM (MRAM) type, a magnetic disk type, and an optical disk type. The electronic device 100 may operate in relation with a web storage performing a storage function of the memory 150 on the Internet as well.

The memory 150 may store various software. For example, a software constituent element may include an operating system (OS) software module, a communication software module, a graphic software module, a user interface software module, a moving picture experts group (MPEG) module, a camera software module, one or more application software modules and the like. Also, a module, a software constituent element, may be expressed as a set of instructions and thus, the module is expressed as an instruction set as well. The module is also expressed as a program as well.

The operating system software module may include several software constituent elements for controlling a general system operation. This controlling of the general system operation may mean, for example, memory management and control, power control and management, etc. Also, the operating system software module may perform even a function of making smooth a communication between several hardware (devices) and software constituent elements (modules). The communication software module may make possible communication with another electronic device such as a computer, a server, a portable terminal or the like through the wireless communication unit 110. And, the communication software module may be constructed to have a protocol structure corresponding to a corresponding communication scheme.

The graphic software module may include several software constituent elements for providing and displaying a graphic on the touch screen 130. The term of graphics may be used as a meaning including a text, a web page, an icon, a digital image, a video, an animation, etc. The user interface software module may include several software constituent elements related with a user interface (UI). For example, the user interface software module may include substance about how a state of the user interface is changed, or in which condition the change of the state of the user interface is made, or the like.

The MPEG module may include a software constituent element for enabling a digital content (e.g., video and audio) related process and function (e.g., content provision, playback, distribution, transmission and the like). The camera software module may include a camera related software constituent element for enabling a camera related process and function.

The application module may include a web browser including a rendering engine, an email, an instant message, a word processing, keyboard emulation, an address book, a widget, digital right management (DRM), iris scan, context cognition, voice recognition, a location based service, etc.

The interface unit 160 may receive data from an external electronic device, or receive a power source, to forward to the respective elements within the electronic device 100. The interface unit 160 may enable to transmit data within the electronic device 100 to the external electronic device. For example, the interface unit 160 may include a wired/wireless headphone port, an external electric charger port, a wired/wireless data port, a memory card port, an audio input/output port, a video input/output port, an earphone port, etc.

The camera module 170 may support a photograph function of the electronic device 100. The camera module 170 may photograph an arbitrary subject in accordance with the control of the control unit 180, and forward photographed data (e.g., image) to the display 131 and the control unit 180. The camera module 170 may include one or more image sensors. For example, the camera module 170 may include a front image sensor (e.g., a front camera) provided on a front surface (e.g., a plane where the display 131 is located) of the electronic device 100, and a rear image sensor (e.g., a rear camera) provided on a rear surface (e.g., a back surface) of the electronic device 100.

The control unit 180 may control a general operation of the electronic device 100. For example, the control unit 180 may perform various control related with music play, voice communication, data communication, video communication, etc. The control unit 180 may be implemented as one or more processors, or may name the control unit 180 as a processor as well. For example, the control unit 180 may include a communication processor (CP), an application processor (AP), an interface (e.g., general purpose input/output (GPIO), an internal memory or the like as separate constituent elements, or may be integrated into one or more integrated circuits. The application processor may execute several software programs, to perform several functions for the electronic device 100, and the communication processor may perform processing and control for voice communication and data communication. Also, the control unit 180 may take charge of a role of executing a specific software module (e.g., an instruction set) stored in the memory 150, to perform specific several functions corresponding to the module.

In various embodiments of the disclosure, the control unit 180 may process an operation of displaying an execution screen of an application on the display 131, an operation of detecting a user input of selecting a menu item, an operation of confirming display ratio configuration information of the displayed application, an operation of displaying a button for altering a display ratio of the application on the basis of the confirmed display ratio configuration information, onto an application card on a list of recently executed applications, and an operation of altering a display ratio of the application according to a selection of the displayed button. The control operation of the control unit 180 of various embodiments of the disclosure is explained in detail with reference to the drawings described later.

The control unit 180 of an embodiment of the disclosure may control various operations related with a general function of the electronic device 100 besides the above function. For example, at execution of a specific application, the control unit 180 may control its operation and screen display. Also, the control unit 180 may receive input signals corresponding to inputs of various touch events or proximity events supported by a touch-based or proximity-based input interface (e.g., the touch screen 130), and control function operation that is based on them. Also, the control unit 180 may control transmission and/or reception of various data, based on wired communication or based on wireless communication as well.

Under the control of the control unit 180, the power supply unit 190 may receive an external power source or an internal power source (e.g., a battery), to supply a power source necessary for an operation of each constituent element. In an embodiment of the disclosure, the power supply unit 190 may power On/Off the display 131, the camera module 170, etc. under the control of the control unit 180.

Various embodiments explained in the disclosure may be implemented within a recording medium readable by a computer or a device similar with this by using software, hardware or a combination of them. By hardware-based implementation, embodiments explained in the disclosure may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical units for other function execution.

A computer-readable recording medium of various embodiments may include a program for executing instructions, the instructions comprising displaying an execution screen of an application, detecting a user input of selecting a menu item, confirming display ratio configuration information of the displayed application, displaying a button for altering a display ratio of the application on the basis of the confirmed display ratio configuration information, onto an application card on a list of recently executed applications, and altering the display ratio of the application according to a selection of the displayed button.

And, in some cases, embodiments explained in the specification may be implemented as the control unit 180 itself Also, by software-based implementation, embodiments such as the procedure and function explained in the specification may be implemented as separate software modules as well. The software modules may each perform one or more functions and operations explained in the specification.

An electronic device (e.g., the electronic device 100 of FIG. 1) of various embodiments may include a memory (e.g., the memory 150 of FIG. 1), a display (e.g., the touch screen 130 of FIG. 1), and a processor (e.g., the control unit 180 of FIG. 1) operatively connected to the memory or the display. The processor may be configured to, in response to detecting a user input of selecting a menu item while an execution screen of an application is displayed on the display, confirm display ratio configuration information, stored in the memory, of the application, display a button for altering a display ratio of the application onto an application card on a list of recently executed applications, based on the confirmed display ratio configuration information, and alter the display ratio of the application according to a selection of the displayed button.

The processor may be configured to alter and display a layout of the application, based on the altered display ratio configuration information.

The processor may be configured to, in response to the display ratio configuration information being a first configuration, generate a first button, and in response to the display ratio configuration information being a second configuration, generate a second button.

The processor may be configured to, in response to detecting a gesture of calling a notification list while the execution screen of the application is displayed, display a new user interface including the button for altering the display ratio of the application.

The processor may be configured to display, together, the button for altering the display ratio of the application on the execution screen of the application.

The processor may be configured to, in response to the button being selected on an execution screen of the application displayed at a first display ratio, alter the display ratio of the application into a second display ratio, and in response to the button being selected on an execution screen of the application displayed at the second display ratio, alter the display ratio of the application into the first display ratio.

The processor may be configured to, in response to receiving an application execution request, determine whether the display ratio of the application is alterable, and in response to the display ratio of the application being alterable, display the button for altering the display ratio of the application on the execution screen of the application.

The processor may be configured to, in response to detecting a preset gesture on the execution screen of the displayed application, determine whether the display ratio of the application is alterable, based on the preset gesture and the display ratio configuration information of the application.

The processor may be configured to, in response to detecting a first preset gesture on the execution screen of the application displayed at the first display ratio or detecting a second preset gesture on the execution screen of the application displayed at the second display ratio, determine whether the display ratio of the application is alterable.

The processor may be configured to generate button information corresponding to the application, based on attribute information of the application.

The processor may be configured to generate at least one of first button information in which the display ratio of the application is fixed to a screen ratio of the electronic device, second button information in which the display ratio of the application is fixed to the application, or third button information indicating that the display ratio of the application is alterable.

The electronic device 100 may have a rectangular form, and have a length of a vertical direction (e.g., longitudinal direction) and a length of a horizontal direction (e.g., transverse direction) shorter than the length of the vertical direction. The electronic device 100 explained below may include the display 131 having a first screen ratio (e.g., about 16:9 or 4:3) and another second screen ratio (e.g., about 18.5:9). Below, the electronic device 100 is explained by way of an example of a form in which the length of the vertical direction is extended longer than the conventional art, but the electronic device 100 may be of a form in which the length of the horizontal direction is extended longer than the conventional art as well. This description does not limit the disclosure. Operations explained below may be for explaining an operation of altering a display ratio of an application according to a screen ratio of the electronic device 100.

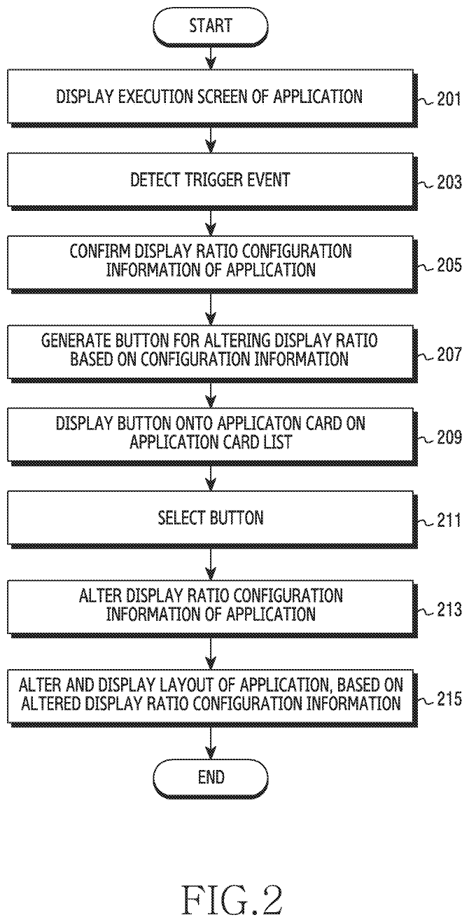

FIG. 2 is a flowchart illustrating an operation method of an electronic device according to various embodiments.

Referring to FIG. 2, in operation 201, the electronic device 100 (e.g., the control unit 180) may display an execution screen of an application on a display (e.g., the display 131 of FIG. 1). The application, a program or software installed in the electronic device 100, may, for example, provide a function of a phone, a message, a messenger, a photo, a video, a game or a camera. The control unit 180 may execute an application according to an application execution request received from a user, and display an execution screen of the executed application in operation 201. For example, the control unit 180 of various embodiments may display the execution screen of the application, based on display ratio configuration information. The application execution request may include a user input such as selecting an icon associated with an application displayed on a home screen of the electronic device 100, or selecting any one application card on a list of recently executed applications, or selecting any one application item on a notification list.

In operation 203, the electronic device 100 (e.g., the control unit 180) may detect a trigger event. Here, the trigger event may be a user input for viewing a list of recently executed applications. The list of the recently executed applications may display, in a card form, information on an application run during a specific time (e.g., one day or one week). The trigger event may include user inputs of various schemes of calling the list of the recently executed applications on an execution screen of the application or a home screen. For example, the trigger event may be an input of selecting a menu icon at a lower menu bar of the electronic device 100.

In operation 205, the electronic device 100 (e.g., the control unit 180) may confirm display ratio configuration information of the application. The control unit 180 may confirm the display ratio configuration information corresponding to the application displayed in operation 201, from the memory 150 of the electronic device 100. The display ratio configuration information of the application may be information configuring a display ratio of the execution screen of the application when the execution screen of the application is displayed on the display 131. For example, the display ratio configuration information of the application may be classified as alterable or be classified as unalterable, according to an attribute of the application. The display ratio configuration information of the application may be configured by a developer of the application. The display ratio configuration information of the application may be configured to have the display ratio optimized to the application.

For example, in response to attribute information of the application being fixed to a screen ratio of the electronic device 100 (e.g., adroid.max_aspect<about 18.5:9), the display ratio configuration information may be unalterable. In response to the attribute information of the application corresponding to a specific attribute (e.g., a game attribute), the display ratio configuration information may be unalterable. In response to a size adjustment attribute of the execution screen of the application corresponding to ‘possible’, the display ratio configuration information may be alterable. In response to the size adjustment attribute of the execution screen of the application corresponding to ‘impossible’, the display ratio configuration information may be unalterable. In response to the execution screen of the application corresponding to the latest operating system (OS) version, the display ratio configuration information may be alterable. In response to the execution screen of the application not corresponding to the latest operating system (OS) version, the display ratio configuration information may be unalterable.

Accordingly, the display ratio configuration information may (1) be fixed to the screen ratio of the electronic device 100, or (2) have a display ratio unalterable, or (3) have the display ratio alterable.

In operation 207, the electronic device 100 (e.g., the control unit 180) may generate a button for display ratio alteration, based on the display ratio configuration information. For example, the control unit 180 may generate the button only for the application of which the display ratio configuration information is alterable into the screen ratio of the electronic device 100. The control unit 180 of various embodiments may generate mutually different buttons, based on the display ratio configuration information. For example, in response to the execution screen of the application displayed in operation 201 being displayed correspondingly to (e.g., being the same as or being compatible with) the screen ratio of the electronic device 100, the control unit 180 may generate a zoom-out button for zooming out and displaying the execution screen of the application. Or, in response to the execution screen of the application displayed in operation 201 not being displayed correspondingly to the screen ratio of the electronic device 100 (e.g., not being the same as or not being compatible with), the control unit 180 may generate a zoom-in button for zooming in and displaying the execution screen of the application. Or, the control unit 180 may generate a button having one form, regardless of the display ratio configuration information.

The control unit 180 of various embodiments may generate a floating button as the button for display ratio alteration. The floating button may be movable onto at least one application card capable of altering a display ratio among applications included in a list of recently executed applications. For example, in response to the button for display ratio alteration being generated as the floating button, the control unit 180 may move the floating button onto at least one application card capable of altering the display ratio, in accordance with a user input of scrolling the list of the recently executed applications.

In operation 209, the electronic device 100 (e.g., the control unit 180) may display the generated button onto the application card included on the application card list. The list of the recently executed applications is displayed in a card form and thus, for example, the application card list may mean the list of the recently executed applications. The application card may correspond to the application displayed in operation 201. Or, the application card may be at least one application card capable of altering a display ratio among the applications included in the application card list. In this case, the control unit 180 may display each button for each application card capable of altering the display ratio. Or, the control unit 180 may display the button onto an application card displayed in a pre-selected location (e.g., a center and/or a lower end), or an application card corresponding to a location where a user input is detected, according to a user's scroll input.

In operation 211, the electronic device 100 (e.g., the control unit 180) may select the button. The control unit 180 may detect a user input of selecting the displayed button. The control unit 180 may identify an application card corresponding to a location where the button is displayed.

In operation 213, the electronic device 100 (e.g., the control unit 180) may alter display ratio configuration information of an application corresponding to the selected button. For example, in response to the button being fixed to the application displayed in operation 201, the control unit 180 may alter the display ratio configuration information of the application displayed in operation 201. Or, in response to the button being moved, the control unit 180 may identify an application card corresponding to a location where the button is displayed, and alter display ratio configuration information of an application corresponding to the identified card.

For example, in response to the button displayed in operation 209 being a button for zooming in and displaying the execution screen of the application correspondingly to the screen ratio of the electronic device 100, the control unit 180 may alter the display ratio configuration information of the application wherein the display ratio of the application corresponds to (e.g., an On state) the screen ratio of the electronic device 100. Or, in response to the button displayed in operation 209 being a button for zooming out the execution screen of the application, the control unit 180 may alter the display ratio configuration information of the application wherein the display ratio of the application does not correspond to (e.g., an Off state) the screen ratio of the electronic device 100.

In operation 215, on the basis of the altered display ratio configuration information, the electronic device 100 (e.g., the control unit 180) may alter a layout of the application, to display the execution screen of the application. In response to displaying a screen of the application (e.g., the execution screen of the application) on the display 131, the control unit 180 may arrange content (or information) configuring (or included in) the application in each region of the display 131. Generally, the control unit 180 may arrange the content configuring the application in each region of the display 131, according to a size of the display 131. However, in response to the display ratio of the application being fixed, it may be impossible to rearrange the content configuring the application adaptively to the size of the display 131. In the disclosure, in response to the display ratio of the application being alterable adaptively to the screen ratio, the control unit 180 may alter a layout of the content configuring the application, based on the screen ratio of the electronic device 100.

The electronic device 100 may have a rectangular form, and have a length of a vertical direction (e.g., a longitudinal direction) and a length of a horizontal direction (e.g., a transverse direction) shorter than the length of the vertical direction (e.g., the longitudinal direction). For example, in response to the execution screen of the application being displayed from the top of the vertical direction toward the bottom (e.g., in a longitudinal mode), the control unit 180 may zoom in and display the execution screen of the application in the vertical direction adaptively to the screen ratio of the electronic device 100. For example, the control unit 180 may zoom in and display the execution screen of the application at about 18.5:9. Or, in response to the execution screen of the application being displayed from the left of the horizontal direction toward the right (e.g., in a transverse mode), the control unit 180 may zoom in and display the execution screen of the application in the horizontal direction adaptively to the screen ratio of the electronic device 100. For example, the control unit 180 may zoom in and display the execution screen of the application at about 9:18.5. Or, in response to the execution screen of the application being displayed correspondingly to the screen ratio of the electronic device 100 in operation 201, the control unit 180 may zoom out and display the execution screen of the application in the vertical direction or the horizontal direction. For example, the control unit 180 may display the execution screen of the application at about 16:9.

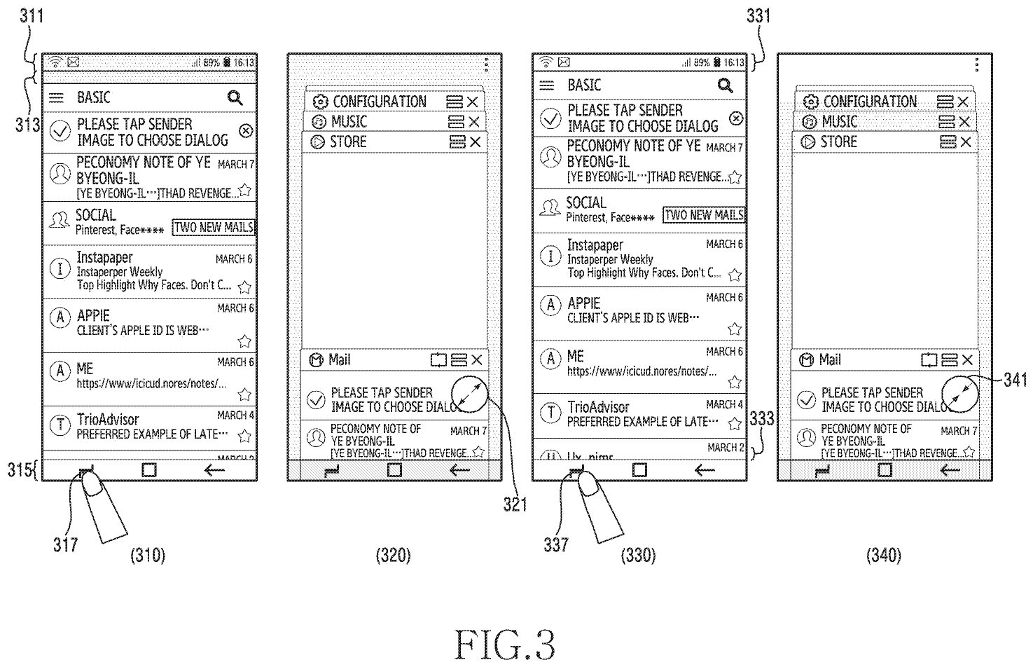

FIG. 3 is a diagram illustrating an example of altering a display ratio of an application by the method of FIG. 2 according to various embodiments.

Referring to FIG. 3, the electronic device 100 (e.g., the control unit 180) may display a first execution screen 310 of an application, based on display ratio configuration information of the application. The display ratio of the first execution screen 310 may not correspond to a screen ratio of the electronic device 100. For example, the screen ratio of the electronic device 100 may have a longitudinal/transverse ratio of about 18.5:9, and the display ratio of the first execution screen 310 may have a longitudinal/transverse ratio of about 16:9. The screen ratio of the electronic device 100 is longer than the display ratio of the first execution screen 310 in a vertical direction (or longitudinal direction), so a dead space 313 (or an unnecessary space (region) or a waste space) may be provided in an upper region on the first execution region 310. The upper region on the first execution screen 310 may include a state display region 311 and the dead space 313.

The state display region 311, a region indicating state information of the electronic device 100, may include, for example, a first signal reception strength (e.g., a Wi-Fi reception strength), notification information (e.g., a message icon), a second signal reception strength (e.g., a mobile communication network reception strength), battery information (e.g., 89% and a battery icon), and time information (e.g., 16:13). The dead space 313 is a region displayed in black. Because the display ratio of the first execution screen 310 does not match with the screen ratio of the electronic device 100, the control unit 180 may display the dead space 313 in part of a screen of the electronic device 100. Also, the control unit 180 may display a menu display region 315 in a lower region beneath the first execution screen 310. The menu display region 315 may be displayed overlapping with the first execution screen 310. For example, the menu display region 315 may be displayed on the first execution screen 310. The menu display region 315 may be processed in shadow.

In response to a user input of selecting a first menu item 317 being detected from the first execution screen 310, the electronic device 100 (e.g., the control unit 180) of various embodiments may display a first list screen 320. The first list screen 320 may be displayed on the display 131 of the electronic device 100 according to a user input of calling a list of recently executed applications. In response to the user input of selecting the first menu item 317 being detected, the control unit 180 may confirm display ratio configuration information about the first execution screen 310. The control unit 180 may display a button for display ratio alteration, based on the display ratio configuration information about the first execution screen 310. The first execution screen 310 does not correspond to the screen ratio of the electronic device 100 and thus, the control unit 180 may display a zoom-in button 321 for zooming in the first execution screen 310. The control unit 180 may display the zoom-in button 321 onto an application card on the first list screen 320. The first list screen 320 may be a screen in which the list of the recently executed applications is displayed in a card form. The control unit 180 may display the zoom-in button 321 onto an application card corresponding to the first execution screen 310 on the first list screen 320.

In response to the zoom-in button 321 on the first list screen 320 being selected, the electronic device 100 (e.g., the control unit 180) of various embodiments may display a second execution screen 330 of the application. The control unit 180 may alter the display ratio configuration information of the application corresponding to the first execution screen 310 in accordance with the selection of the zoom-in button 321. For example, in response to the display ratio configuration information of the application being an Off state in the first execution screen 310, the display ratio configuration information of the application may be an On state in the second execution screen 330. Inversely, in response to the display ratio configuration information of the application being an On state in the first execution screen 310, the display ratio configuration information of the application may be an Off state in the second execution screen 330. On the basis of the altered display ratio configuration information, the control unit 180 may control to alter a layout of the application and display an execution screen of the application. The second execution screen 330 may be the execution screen of the application of which the layout in the first execution screen 310 is altered. The second execution screen 330 does not provide a dead space in an upper region, and may include a new region 333 not ever displayed on the first execution screen 310. A height of the new region 333 may be the same as a height of the dead space 313. The control unit 180 may zoom in the execution screen of the application as much as the dead space 313 of the first execution screen 310, as in the second execution screen 330. Here, the zoomed-in region may mean the new region 333.

The control unit 180 of various embodiments may include even a state display region 331 in the execution screen of the application according to an attribute of the application. In this case, in the execution screen of the application, the state display region 331 may not be displayed. Or, the control unit 180 may maintain the state display region 331, while displaying the second execution screen 330. In this case, the state display region 331 may be displayed differently from a background color of the second execution screen 330. Or, the control unit 180 may display the state display region 331 overlapping with the second execution screen 330. For example, the state display region 331 may be displayed on the second execution screen 330. In this case, the state display region 331 may be displayed in the background color of the second execution screen 330.

In response to a user input of selecting a second menu item 337 (e.g., a menu of calling a list of recently executed applications) being detected from the second execution screen 330, the electronic device 100 (e.g., the control unit 180) of various embodiments may display a second list screen 340. Here, the second menu item 337 is called “second” for the sake of differentiation with the first menu item 317, and the second menu item 337 may be the same as the first menu item 317. In response to the user input of selecting the second menu item 337 being detected, the control unit 180 may confirm display ratio configuration information about the second execution screen 330. The control unit 180 may provide a button for display ratio alteration, based on the display ratio configuration information about the second execution screen 330. The second execution screen 330 corresponds to the screen ratio of the electronic device 100 and thus, the control unit 180 may provide a zoom-out button 341 for zooming out the second execution screen 330. The control unit 180 may display the zoom-out button 341 onto an application card on the second list screen 340. The control unit 180 may display the zoom-out button 341 onto an application card corresponding to the second execution screen 330 on the second list screen 340.

FIG. 3 shows the zoom-in button 321 and the zoom-out button 341 differently, but the zoom-in button 321 and the zoom-out button 341 may have the same form as well. Also, the zoom-in button 321 and the zoom-out button 341 may be moved according to a user input of scrolling on the first list screen 320 or the second list screen 340, and be displayed onto at least one application card capable of altering a display ratio as well.

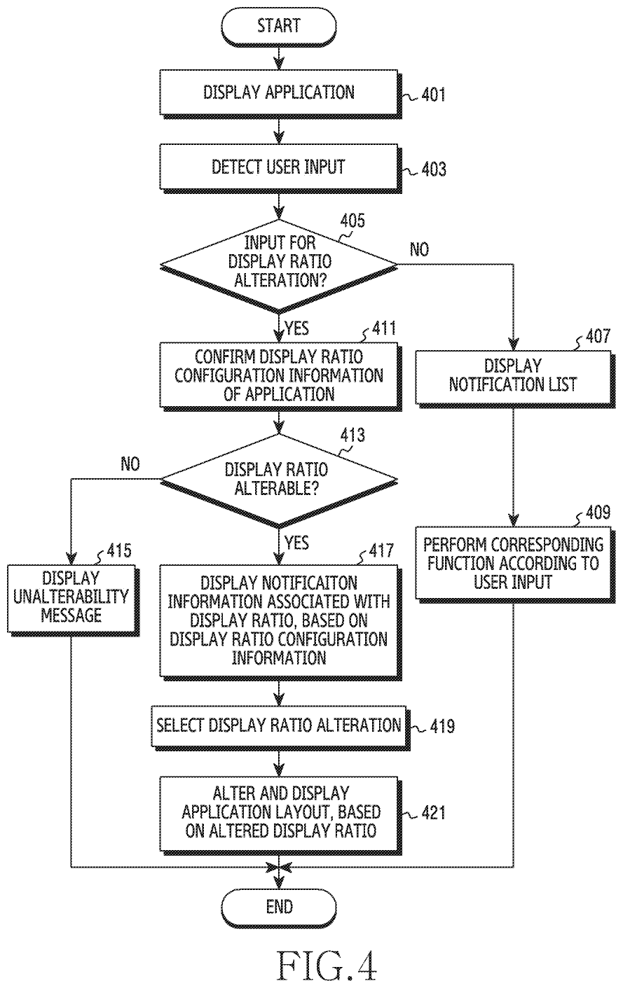

FIG. 4 is a flowchart illustrating a method for altering a display ratio of an application according to various embodiments.

Referring to FIG. 4, in operation 401, the electronic device 100 (e.g., the control unit 180) may display an application. In operation 401, the displaying of the application may mean displaying an execution screen of the application on the display 131. The control unit 180 may display the execution screen of the application, based on display ratio configuration information of the application.

In operation 403, the electronic device 100 (e.g., the control unit 180) may detect a user input. The user input corresponds to a preset gesture, and may be, for example, an input of calling a notification list, or be an input for altering a display ratio of the application. For example, the input of calling the notification list may be an input in which one touch input beginning from an upper bezel of the electronic device 100 is moved (e.g., dragged) up to part of an upper end of the display 131. Or, the input of altering the display ratio of the application may be an input in which at least two touch inputs beginning from the upper bezel of the electronic device 100 are moved (e.g., dragged) up to part of the upper end of the display 131.

According to various embodiments, the input of calling the notification list and the input of altering the display ratio of the application may be the same as well. In this case, in response to the user input being detected, the control unit 180 may determine whether the display ratio of the application is alterable. In response to it being alterable, the control unit 180 may display notification information for altering the display ratio of the application. In response to it being unalterable, the control unit 180 may display a notification list.

In operation 405, the electronic device 100 (e.g., the control unit 180) may determine whether the detected user input is an input for display ratio alteration. In response to the detected user input being the input for display ratio alteration, the control unit 180 may perform operation 411. In response to the detected user input not being the input for display ratio alteration (e.g., an input for controlling the application), the control unit 180 may perform operation 407.

In response to the detect user input not being the input for display ratio alteration, in operation 407, the electronic device 100 (e.g., the control unit 180) may display a notification list. The control unit 180 may display, in a notification list form, a message not confirmed by a user among messages received from a service server or a counterpart electronic device. For example, the notification list may include message information (e.g., substance, sender information, a message reception time, etc.) not confirmed by the user among a push message received from the service server. For example, the service server may include an integration server, a provider server, a content server, an Internet server, or a cloud server.

In operation 409, the electronic device 100 (e.g., the control unit 180) may perform a corresponding function according to a user input detected on the notification list. For example, in response to any one message information being selected from the notification list, the control unit 180 may execute an application corresponding to the message information, and display the message information by means of the executed application. Or, the control unit 180 may delete, from the notification list, the any one message information selected from the notification list.

In response to the detected user input being the input for display ratio alteration, in operation 411, the electronic device 100 (e.g., the control unit 180) may confirm the display ratio configuration information of the application. The memory 150 of the electronic device 100 may store display ratio configuration information of each application. The control unit 180 may confirm the display ratio configuration information corresponding to the application displayed in operation 401, from the memory 150.

In operation 413, the electronic device 100 (e.g., the control unit 180) may determine whether the display ratio is alterable. The control unit 180 may determine whether the display ratio configuration information confirmed in operation 411 is alterable. The display ratio configuration information may have the display ratio of the application that (1) is fixed and set to a screen ratio of the electronic device 100, or (2) is unalterable into the screen ratio of the electronic device 100 but is fixed and set to the application, or (3) is alterable into the screen ratio of the electronic device 100 but is set to the screen ratio of the electronic device 100, or (4) is alterable into the screen ratio of the electronic device 100 but is set to the display ratio of the application.

In response to the display ratio configuration information of the application being fixed to the screen ratio of the electronic device 100, the display ratio configuration information of the application may be unalterable. In response to the display ratio configuration information of the application being unalterable into the screen ratio of the electronic device 100 but being fixed to the application, the display ratio configuration information of the application may be unalterable. For the remaining condition, the display ratio configuration information of the application may be alterable.

In response to the display ratio of the application being alterable, the control unit 180 may perform operation 417. In response to the display ratio of the application being unalterable, the control unit 180 may perform operation 415.

In response to the display ratio of the application being unalterable, in operation 415, the electronic device 100 (e.g., the control unit 180) may display an unalterability message. In response to the display ratio configuration information of the application being fixed to the screen ratio of the electronic device 100, or being unalterable into the screen ratio of the electronic device 100 but being fixed to the application, the unalterability message may be displayed on the display 131. The unalterability message, an error message, may be displayed in the form of pop-up. The unalterability message may include an unalterability icon (e.g., X) or an unalterability guide text (e.g., You cannot alter a display ratio.).

In response to a specific time elapsing after the unalterability message is displayed in the form of pop-up, the control unit 180 of various embodiments may be terminated. Or, in response to the specific time elapsing after the unalterability message is displayed, the control unit 180 may display a notification list. For example, in response to a specific time (e.g., 3 seconds or 5 seconds) elapsing by counting time after the unalterability message is displayed, the control unit 180 may return to operation 407. Or, in response to a specific time elapsing after the unalterability message is displayed, the control unit 180 may display a first execution screen of the application. That is, in response to the specific time (e.g., 3 seconds or 5 seconds) elapsing by counting time after the unalterability message is displayed, the control unit 180 may return to operation 401.

In response to the display ratio of the application being alterable, in operation 417, the electronic device (e.g., the control unit 180) may display notification information associated with the display ratio, based on the display ratio configuration information. For example, in response to the display ratio configuration information being set to the screen ratio of the electronic device 100, the control unit 180 may display notification information which includes display ratio guidance information (e.g., about 18.5:9 is now in use. Will you alter?) and button information (e.g., a display ratio alter button or a cancel button). Or, for example, in response to the display ratio configuration information being set to the display ratio of the application, the control unit 180 may display notification information which includes display ratio guidance information (e.g., about 16:9 is now in use. Will you alter?) and button information (e.g., a display ratio alter button or a cancel button).

In operation 419, the electronic device 100 (e.g., the control unit 180) may select display ratio alteration. For example, in response to a user input of selecting an alter button from the notification information displayed in operation 417 being detected, the control unit 180 may determine that the display ratio alteration is selected. For example, in response to the alter button being selected in course of using the screen ratio of the electronic device 100 (e.g., about 18.5:9), the control unit 180 may alter the display ratio of the application into a display ratio (e.g., about 16:9) different from the screen ratio of the electronic device 100. Or, in response to the alter button being selected in course of not using the screen ratio of the electronic device 100 (e.g., about 16:9), the control unit 180 may alter the display ratio of the application into the screen ratio (e.g., about 18.5:9) of the electronic device 100.

In operation 421, the electronic device 100 (e.g., the control unit 180) may alter and display an application layout, based on the altered display ratio of the application. Operation 421 is the same as or is similar with operation 215 of FIG. 2 and thus, its detailed description may be omitted. For example, in response to the execution screen of the application being displayed in a vertical direction, the control unit 180 may zoom in and display the execution screen of the application in the vertical direction adaptively to the screen ratio of the electronic device 100. Or, in response to the execution screen of the application being displayed in the horizontal direction, the control unit 180 may zoom in and display the execution screen of the application in the horizontal direction adaptively to the screen ratio of the electronic device 100. Or, in response to the execution screen of the application being displayed correspondingly to the screen ratio of the electronic device 100 in operation 401, the control unit 180 may zoom out and display the execution screen of the application in the vertical direction or the horizontal direction.

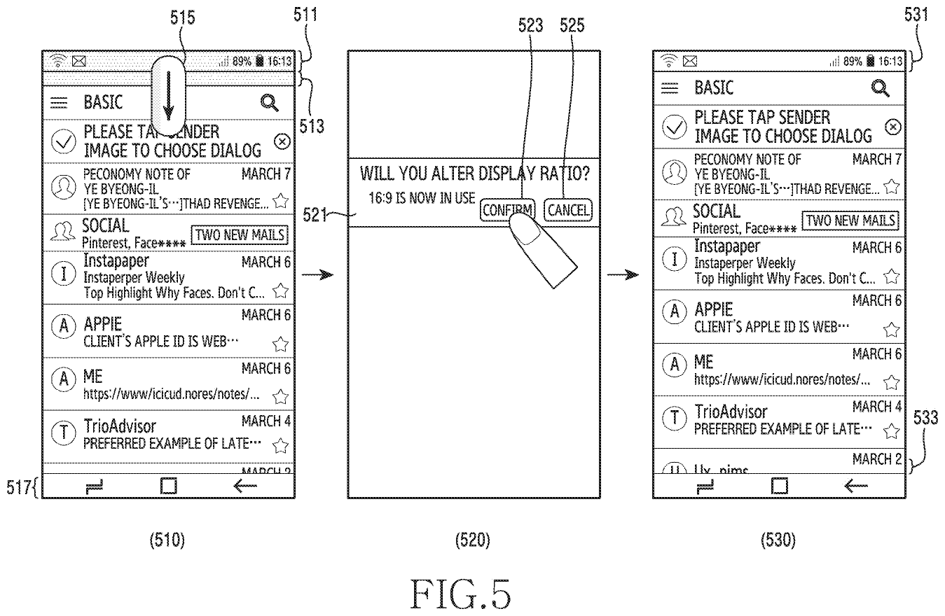

FIG. 5 is a diagram illustrating an example of altering a display ratio of an application by the method of FIG. 4 according to various embodiments.

Referring to FIG. 5, the electronic device 100 (e.g., the control unit 180) may display a first execution screen 510 of an application, based on display ratio configuration information of the application. A display ratio of the first execution screen 510 may not correspond to a screen ratio of the electronic device 100. In this case, a dead space 513 may be provided in an upper region on the first execution screen 510. The upper region on the first execution screen 510 may include a state display region 511 and the dead space 513. The dead space 513 is a region displayed in black, and the control unit 180 may display the dead space 313 in part of a screen of the electronic device 100, because the display ratio of the first execution screen 510 does not match with the screen ratio of the electronic device 100. Also, the control unit 180 may display a menu display region 517 in a lower region beneath the first execution screen 510.

In response to a user input 515 for display ratio alteration being detected from the first execution screen 510, the electronic device 100 (e.g., the control unit 180) of various embodiments may display a user interface 520 including notification information 521. Here, the user input 515 may be an input in which at least one touch input beginning from an upper bezel of the electronic device 100 is moved (e.g., dragged) up to part of an upper end of the display 131. The user input 515 may be different from, or be the same as a user input of calling a notification list. In response to the user input 515 being detected, the control unit 180 may confirm the display ratio configuration information of the application corresponding to the first execution screen 510. The control unit 180 may determine whether the confirmed display ratio configuration information of the application is alterable.

Though not illustrated, in response to the confirmed display ratio configuration information of the application being unalterable, the control unit 180 may display an unalterability message. In response to the display ratio configuration information of the application being alterable, the control unit 180 may display the user interface 520 including the notification information 521. The notification information 521 may include display ratio guidance information (e.g., about 16:9 is now in use. Will you alter?) and button information (e.g., a confirm button 523 and a cancel button 525).

In response to the confirm button 523 being selected from the notification information 521, the control unit 180 may display a second execution screen 530 of the application. The control unit 180 may alter the display ratio configuration information of the application corresponding to the first execution screen 510 according to a selection of the confirm button 523. The second execution screen 530 may be an execution screen of the application whose layout is altered into a display ratio of about 18.5:9. The second execution screen 530 does not provide a dead space in an upper region, and may include a new region 533 not ever displayed on the first execution screen 510. A height of the new region 533 may be the same as a height of the dead space 513. The control unit 180 may include even a state display region 531 in the execution screen of the application according to an attribute of the application. In response to the cancel button 525 being selected from the notification information 521, the control unit 180 may display the first execution screen 510 of the application.

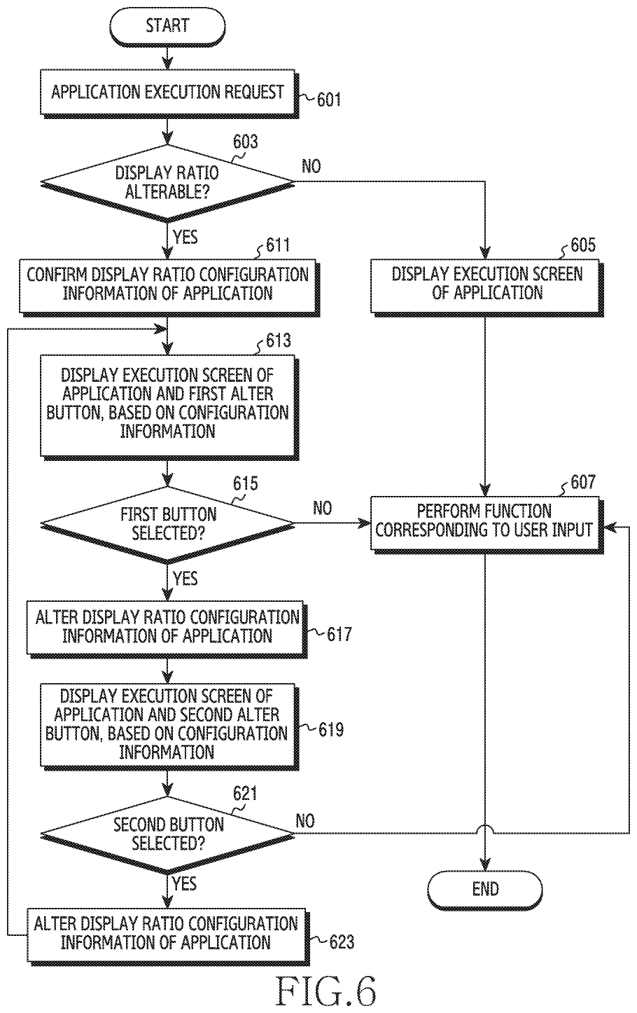

FIG. 6 is a flowchart illustrating a method for altering a display ratio of an application on the basis of a button according to various embodiments.

Referring to FIG. 6, in operation 601, the electronic device 100 (e.g., the control unit 180) may receive an application execution request. For example, the application execution request may include a user input such as selecting an icon associated with an application displayed on a home screen of the electronic device 100, or selecting any one application card on a list of recently executed applications, or selecting any one application item on a notification list.

In operation 603, the electronic device 100 (e.g., the control unit 180) may determine whether a display ratio of an execution requested application is alterable. For example, the control unit 180 may confirm display ratio configuration information of the application stored in the memory 150. The display ratio configuration information may be alterable into a screen ratio of the electronic device 100 or a display ratio of the application, or may be unalterable into the screen ratio of the electronic device 100 or the display ratio of the application.

In response to the display ratio of the execution requested application being alterable, the control unit 180 may perform operation 611. In response to the display ratio of the execution requested application being unalterable, the control unit 180 may perform operation 605.

In response to the display ratio of the execution requested application being unalterable, in operation 605, the electronic device 100 (e.g., the control unit 180) may display the execution screen of the execution requested application. For example, the execution screen of the application may be displayed at a screen ratio of the electronic device 100 (e.g., the second execution screen 330 or the second execution screen 530), or may be displayed at the display ratio of the application (e.g., the first execution screen 310 or the first execution screen 510). That is, a display ratio of the execution screen of the application displayed in operation 605 may be unalterable. Also, in response to a user input being detected after operation 605, in operation 607, the control unit 180 may perform a function of the detected user input.

In response to the display ratio of the execution requested application being alterable, in operation 611, the electronic device 100 (e.g., the control unit 180) may confirm the display ratio configuration information of the application.

In operation 613, on the basis of the confirmed display ratio configuration information, the electronic device 100 (e.g., the control unit 180) may display an execution screen of the application and a first alter button. For example, in response to the confirmed display ratio configuration information being set as the screen ratio of the electronic device 100, the control unit 180 may display the execution screen (e.g., the second execution screen 330 and the second execution screen 530) of the application adaptively to the screen ratio of the electronic device 100, and display the first alter button (e.g., a zoom-out switching button) on the execution screen of the application. Or, in response to the confirmed display ratio configuration information not being set as the screen ratio of the electronic device 100, the control unit 180 may display the execution screen (e.g., the first execution screen 310 and the first execution screen 510) of the application according to the display ratio of the application, and display the first alter button (e.g., a zoom-in switching button) on the execution screen of the application. In other words, the control unit 180 may display the first alter button each differently (e.g., the zoom-out switching button or the zoom-in switching button), based on the confirmed display ratio configuration information. According to some embodiment, the control unit 180 may identically display the first alter button (e.g., a ratio alteration notification button) regardless of the confirmed display ratio configuration information.

In operation 615, the electronic device 100 (e.g., the control unit 180) may determine whether the displayed first button (e.g., the first alter button) is selected. While the execution screen of the application is displayed, the control unit 180 may detect a user input. The control unit 180 may determine whether the detected user input has been detected on the first button, or has been detected on the execution screen of the application, or whether an input for control of a function of the electronic device 100 has been detected.

In response to the first button being selected, the control unit 180 may perform operation 617. In response to the first button not being selected, the control unit 180 may perform operation 607.

In response to the first button not being selected, in operation 607, the electronic device 100 (e.g., the control unit 180) may perform a function corresponding to a user input. For example, in response to detecting a user input within the execution screen of the application, the control unit 180 may perform a function of the application corresponding to the detected user input. In response to detecting a user input for control of a function of the electronic device 100 while the execution screen of the application is displayed, the control unit 180 may perform a function of the electronic device 100. For example, the user input for control of the function of the electronic device 100 may be at least one of an input (e.g., a touch input dragging from an upper bezel to a display) of calling a notification list, an input (e.g., menu item selection) of calling a list of recently executed applications, an input of ending an application, an input of calling a home screen, and/or a selection of a button for electronic device 100 locking. Besides this, the user input for control of the function of the electronic device 100 may include a user input not related with the execution of the function of the application.

In response to the first button being selected, in operation 617, the electronic device 100 (e.g., the control unit 180) may alter the display ratio configuration information of the application. For example, in response to the first button (e.g., the zoom-out switching button) being selected while the execution screen of the application is displayed at the screen ratio (e.g., about 18.5:9) of the electronic device 100 in operation 613, the control unit 180 may alter the display ratio configuration information of the application into the display ratio (e.g., about 16:9) of the application. In response to the first button (e.g., the zoom-in switching button) being selected while the execution screen of the application is displayed at the display ratio (e.g., about 16:9) of the application in operation 613, the control unit 180 may alter the display ratio configuration information of the application into the screen ratio (e.g., about 18.5:9) of the electronic device 100.

In operation 619, the electronic device 100 (e.g., the control unit 180) may display the execution screen of the application and a second alter button, based on the altered display ratio configuration information. For example, in response to the display ratio configuration information being altered into the screen ratio of the electronic device 100, the control unit 180 may display the execution screen (e.g., the second execution screen 330 and the second execution screen 530) of the application adaptively to the screen ratio of the electronic device 100, and display the second alter button (e.g., the zoom-out switching button) on the execution screen of the application. Or, in response to the confirmed display ratio configuration information being altered into the display ratio of the application, the control unit 180 may display the execution screen (e.g., the first execution screen 310 and the first execution screen 510) of the application according to the display ratio of the application, and display the second alter button (e.g., the zoom-in switching button) on the execution screen of the application.

The first alter button and the second alter button of various embodiments may be the same as well, and may be different as well. For example, the first alter button and the second alter button may be displayed each differently, based on the display ratio configuration information. Or, the first alter button and the second alter button may be displayed identically (e.g., a ratio alteration notification button) regardless of the confirmed display ratio configuration information.

In operation 621, the electronic device 100 (e.g., the control unit 180) may determine whether the displayed second button (e.g., the second alter button) is selected. While the execution screen of the application is displayed, the control unit 180 may detect a user input. The control unit 180 may determine whether the detected user input has been detected on the second button, or has been detected on the execution screen of the application, or whether an input for control of a function of the electronic device 100 has been detected.

In response to the second button being selected, the control unit 180 may perform operation 623. In response to the second button not being selected, the control unit 180 may perform operation 607.

In response to the second button being selected, in operation 623, the electronic device 100 (e.g., the control unit 180) may alter the display ratio configuration information of the application. For example, in response to the second button (e.g., the zoom-out switching button) being selected while the execution screen of the application is displayed at the screen ratio (e.g., about 18.5:9) of the electronic device 100 in operation 617, the control unit 180 may alter the display ratio configuration information of the application into the display ratio (e.g., about 16:9) of the application. In response to the second button (e.g., the zoom-in switching button) being selected while the execution screen of the application is displayed at the display ratio (e.g., about 16:9) of the application in operation 617, the control unit 180 may alter the display ratio configuration information of the application into the screen ratio (e.g., about 18.5:9) of the electronic device 100.

After altering the display ratio configuration information of the application, the control unit 180 may return to operation 613. In response to returning to operation 613, the control unit 180 may display the execution screen of the application and the first alter button, based on the altered display ratio configuration information. The control unit 180 of various embodiments may convert the execution screen of the application from the display ratio of the application to the screen ratio of the electronic device 100 by a selection of the alter button within the execution screen of the application, or easily convert from the screen ratio of the electronic device 100 to the display ratio of the application.

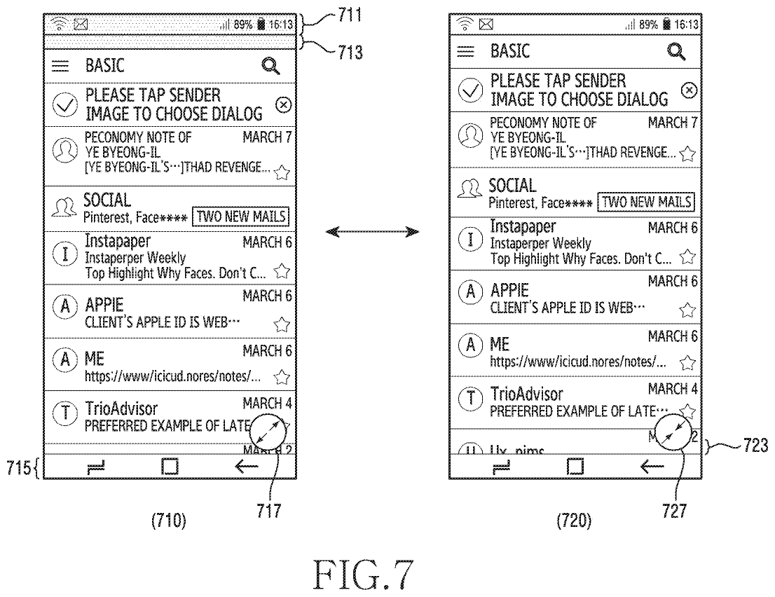

FIG. 7 is a diagram illustrating an example of altering a display ratio of an application by the method of FIG. 6 according to various embodiments.

Referring to FIG. 7, the electronic device 100 (e.g., the control unit 180) may display a first execution screen 710 of an application and a first alter button 717 of the first execution screen 710, based on display ratio configuration information. The first alter button 717 is for altering a display ratio of the application, and may be, for example, a ‘zoom-in switching button’. The display ratio of the first execution screen 710 does not correspond to a screen ratio of the electronic device 100, and may be about ‘16:9’. According to the display ratio of the first execution screen 710, a dead space 713 may be provided in an upper region on the first execution screen 710. The upper region on the first execution screen 710 may include a state display region 711 and the dead space 713. Also, the control unit 180 may display a menu display region 715 in a lower region beneath the first execution screen 710.

In response to the first alter button 717 being selected on the first execution screen 710, the electronic device 100 (e.g., the control unit 180) of various embodiments may display a second execution screen 720 of the application and a second alter button 727 of the second execution screen 720. The control unit 180 may alter display ratio configuration information of the application corresponding to the first execution screen 710 according to a selection of the first alter button 717. The second alter button 727 is for altering the display ratio of the application, and may be, for example, a ‘zoom-out switching button’. The second execution screen 720 may be an execution screen of the application whose layout is altered into a display ratio of about 18.5:9. The second execution screen 720 does not provide a dead space in an upper region, and may include a new region 723 not ever displayed on the first execution screen 710. A height of the new region 723 may be the same as a height of the dead space 713. That is, the control unit 180 may zoom in the execution screen of the application as much as the dead space 713 of the first execution screen 710, as in the second execution screen 720. In response to the first alter button 717 being selected on the first execution screen 710, the electronic device 100 (e.g., the control unit 180) of various embodiments may convert the display ratio of the application from the first execution screen 710 to the second execution screen 720. Also, in response to the second alter button 727 being selected on the second execution screen 720, the electronic device 100 (e.g., the control unit 180) may convert the display ratio of the application from the second execution screen 720 to the first execution screen 710. The first alter button 717 and the second alter button 727 of various embodiments may be the same as well, and may be different as well. For example, the first alter button 717 may be a zoom-in switching button, and the second alter button 727 may be a zoom-out switching button. Or, the first alter button 717 and the second alter button 727 may be ratio alteration notification buttons of a new form not illustrated in FIG. 7 as well.

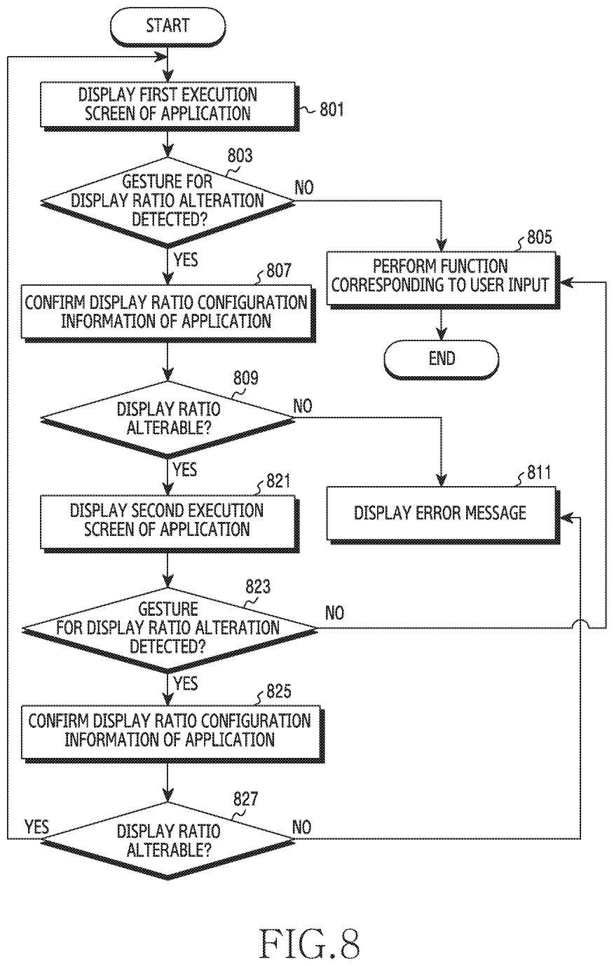

FIG. 8 is a flowchart illustrating a method for altering a display ratio of an application on the basis of a gesture according to various embodiments.

Referring to FIG. 8, in operation 801, the electronic device 100 (e.g., the control unit 180) may display a first execution screen of an application. For example, the first execution screen may be an execution screen of the application having a display ratio (e.g., the first execution screen 310 or the first execution screen 510) of the application, or be an execution screen of the application having a screen ratio (e.g., the second execution screen 330 or the second execution screen 530) of the electronic device 100.

In operation 803, the electronic device 100 (e.g., the control unit 180) may determine whether a gesture for display ratio alternation is detected. The control unit 180 may detect a gesture (e.g., a user input and/or a touch input) while the first execution screen of the application is displayed. The gesture may be at least one of a gesture for display ratio alteration, a gesture for controlling the application, or a gesture for control of a function of the electronic device 100. For example, the gesture for display ratio alteration may be pinch-in or pinch-out. The pinch-in may be an input of dragging in a direction in which a distance (or a gap) between at least two touch inputs gets narrow to each other. Or, the pinch-out may be an input of dragging in a direction in which the distance between the at least two touch inputs gets distant from each other.

In response to the detected gesture being the gesture for display ratio alteration, the control unit 180 may perform operation 807. In response to the detected gesture not being the gesture for display ratio alteration, the control unit 180 may perform operation 805.

In response to not being the gesture for display ratio alteration, in operation 805, the electronic device 100 (e.g., the control unit 180) may perform a function corresponding to a user input. In response to detecting a gesture within the first execution screen of the application, the control unit 180 may perform a function of the application corresponding to the detected gesture. In response to detecting the user input for control of the function of the electronic device 100 while the first execution screen of the application is displayed, the control unit 180 may perform a function of the electronic device 100.

In response to being the gesture for display ratio alteration, in operation 807, the electronic device 100 (e.g., the control unit 180) may confirm display ratio configuration information of the application. The control unit 180 may confirm the display ratio configuration information of the application stored in the memory 150.

In operation 809, the electronic device 100 (e.g., the control unit 180) may determine whether a display ratio of the application is alterable. The control unit 180 may determine whether the display ratio of the application is alterable, based on the detected gesture and the display ratio configuration information of the application. For example, in response to detecting the gesture for display ratio alteration in operation 803 but not being capable of altering the display ratio of the application, the control unit 180 may determine that the display ratio of the application is unalterable. Or, in response to the gesture detected in operation 803 not matching with display ratio alteration information (e.g., in response to being inputs opposite to each other (or running counter to each other)), the control unit 180 may determine that the display ratio of the application is unalterable. For example, in response to the detected gesture being an input of decreasing the display ratio by ‘pinch-in’ whereas the display ratio configuration information having been set as a zoom-out ratio (e.g., about 16:9), the control unit 180 may determine that the display ratio of the application is unalterable. Or, in response to the detected gesture being an input of increasing the display ratio by ‘pinch-out’ whereas the display ratio configuration information having been set as a zoom-in ratio (e.g., about 18.5:9), the control unit 180 may determine that the display ratio of the application is unalterable. The zoom-out ratio may be the display ratio of the application, and the zoom-in ratio may be the screen ratio of the electronic device 100.

The control unit 180 of various embodiments may determine that the display ratio of the application is alterable only in response to the gesture detected in operation 803 and the display ratio configuration information confirmed in operation 807 correspond to each other. For example, in response to the gesture detected in operation 803 being the ‘pinch-out’, and the display ratio configuration information confirmed in operation 807 being a display ratio of about 16:9, the control unit 180 may determine that the display ratio of the application is alterable. Or, in response to the gesture detected in operation 803 being the ‘pinch-in’, and the display ratio configuration information confirmed in operation 807 being a display ratio of about 18.5:9, the control unit 180 may determine that the display ratio of the application is alterable.

In response to the display ratio of the application being alterable, the control unit 180 may perform operation 821. In response to the display ratio of the application being unalterable, the control unit 180 may perform operation 811.

In response to the display ratio of the application being unalterable, in operation 811, the electronic device 100 (e.g., the control unit 180) may display an error message. According to various embodiments, the error message may be a guidance message “You cannot alter a display ratio” displayed in the form of pop-up. In response to a specific time elapsing after the displaying of the error message, the control unit 180 may terminate. Or, in response to the specific time elapsing after the displaying of the error message, the control unit 180 may display the first execution screen of the application. That is, the control unit 180 may display the error message and in response to the specific time (e.g., 3 seconds or 5 seconds) elapsing by counting time, may return to operation 801.

In response to the display ratio of the application being alterable, in operation 821, the electronic device 100 (e.g., the control unit 180) may display a second execution screen of the application. For example, the second execution screen may be an execution screen of the application having the display ratio (e.g., the first execution screen 310 or the first execution screen 510) of the application, or be an execution screen of the application having the screen ratio (e.g., the second execution screen 330 or the second execution screen 530) of the electronic device 100. The second execution screen may be an execution screen of the application having a display ratio different from that of the first execution screen. For example, in response to the first execution screen being displayed at a display ratio of about 16:9, and the gesture detected in operation 803 being ‘pinch-out’, the control unit 180 may display the second execution screen at a display ratio of about 18.5:9. Or, in response to the first execution screen being displayed at a display ratio of about 18.5:9, and the gesture detected in operation 803 being ‘pinch-in’, the control unit 180 may display the second execution screen at a display ratio of about 16:9.

In operation 823, the electronic device 100 (e.g., the control unit 180) may determine whether a gesture for display ratio alternation is detected. The control unit 180 may detect the gesture (e.g., a user input and/or a touch input) while the second execution screen of the application is displayed. Operation 823 is the same as or is similar with operation 803 and therefore, its detailed description may be omitted.

In response to the detected gesture being the gesture for display ratio alteration, the control unit 180 may perform operation 825. In response to the detected gesture not being the gesture for display ratio alteration, the control unit 180 may perform operation 805.

In response to being the gesture for display ratio alteration, in operation 825, the electronic device 100 (e.g., the control unit 180) may confirm display ratio configuration information of the application. Operation 825 is the same as or is similar with operation 807 and therefore, its detailed description may be omitted.

In operation 827, the electronic device 100 (e.g., the control unit 180) may determine whether a display ratio of the application is alterable. The control unit 180 may determine whether the display ratio of the application is alterable, based on the detected gesture and the display ratio configuration information of the application. Operation 827 is the same as or is similar with operation 809 and therefore, its detailed description may be omitted.

In response to the display ratio of the application being alterable, the control unit 180 may return to operation 801. In response to the display ratio of the application being unalterable, the control unit 180 may return to operation 811.

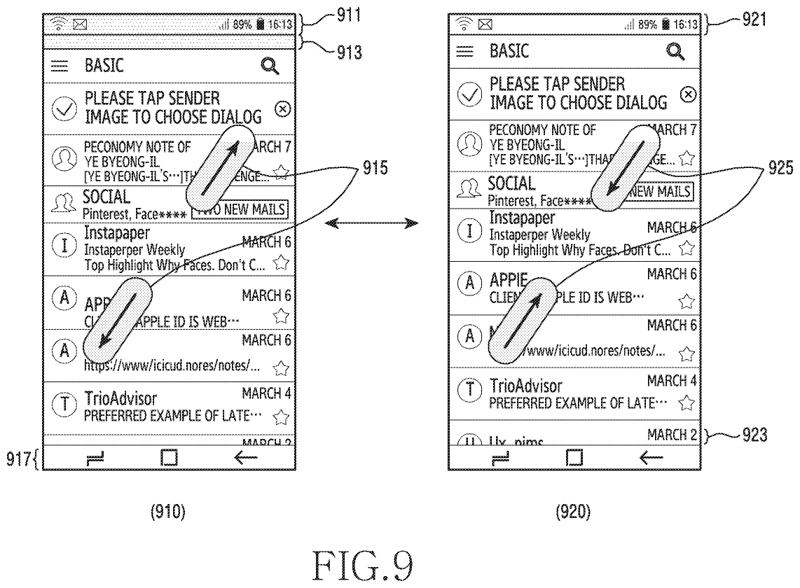

FIG. 9 is a diagram illustrating an example of altering a display ratio of an application by the method of FIG. 8 according to various embodiments.

Referring to FIG. 9, the electronic device 100 (e.g., the control unit 180) may display a first execution screen 910 of an application, based on display ratio configuration information of the application. A display ratio of the first execution screen 910 does not correspond to a screen ratio of the electronic device 100, and may be a first screen ratio (e.g., about ‘16:9’). According to the display ratio of the first execution screen 910, a dead space 913 may be provided in an upper region on the first execution screen 910. The upper region on the first execution screen 910 may include a state display region 911 and the dead space 913. Also, the control unit 180 may display a menu display region 917 in a lower region beneath the first execution screen 910.

In response to a first gesture 915 being detected from the first execution screen 910, the electronic device 100 (e.g., the control unit 180) of various embodiments may display a second execution screen 920 of the application. The control unit 180 may determine whether a display ratio of the application is alterable, based on the first gesture 915 and the display ratio of the first execution screen 910. For example, in response to the first gesture 915 and the display ratio of the first execution screen 910 satisfying a preset condition, the control unit 180 may determine that the display ratio of the application is alterable, and alter the display ratio configuration information of the application. For example, in response to the first gesture 915 being ‘pinch-out’ (e.g., a gesture for display ratio alteration), and the display ratio of the first execution screen 910 being a first screen ratio (about 16:9), the control unit 180 may determine that the display ratio of the application is alterable.

The second execution screen 920 may be an execution screen of the application whose layout is altered into a display ratio of a second screen ratio (e.g., about 18.5:9). The second execution screen 920 does not provide a dead space in an upper region, and may include a new region 923 not ever displayed on the first execution screen 910. A height of the new region 923 may be the same as a height of the dead space 913. For example, the control unit 180 may zoom in the execution screen of the application as much as the dead space 913 of the first execution screen 910, as in the second execution screen 920. The control unit 180 may include even a state display region 921 in the execution screen of the application according to an attribute of the application.

In response to a second gesture 925 being detected from the second execution screen 920, the electronic device 100 (e.g., the control unit 180) of various embodiments may display the first execution screen 910 of the application. The control unit 180 may determine whether the display ratio of the application is alterable, based on the second gesture 925 and the display ratio of the second execution screen 920. For example, in response to the second gesture 925 and the display ratio of the second execution screen 920 satisfying a preset condition, the control unit 180 may determine that the display ratio of the application is alterable, and display the first execution screen 910. For example, in response to the second gesture 925 being ‘pinch-in’, and the display ratio of the second execution screen 920 being the second screen ratio (about 18.5:9), the control unit 180 may determine that the display ratio of the application is alterable.

In response to having detected the first gesture 915 or the second gesture 825 but not being capable of altering the display ratio of the application, the control unit 180 of various embodiments may determine that the display ratio of the application is unalterable. Or, in response to the second gesture 925 corresponding to the pinch-in being detected while the first execution screen 910 is displayed, or the first gesture 915 corresponding to the pinch-out being detected while the second execution screen 920 is displayed, the control unit 180 may determine that the display ratio of the application is unalterable, because the gesture and the display ratio of the execution screen do not match with each other. In response to it being identified that the display ratio of the application is unalterable, the control unit 180 may output (or display) an error message.

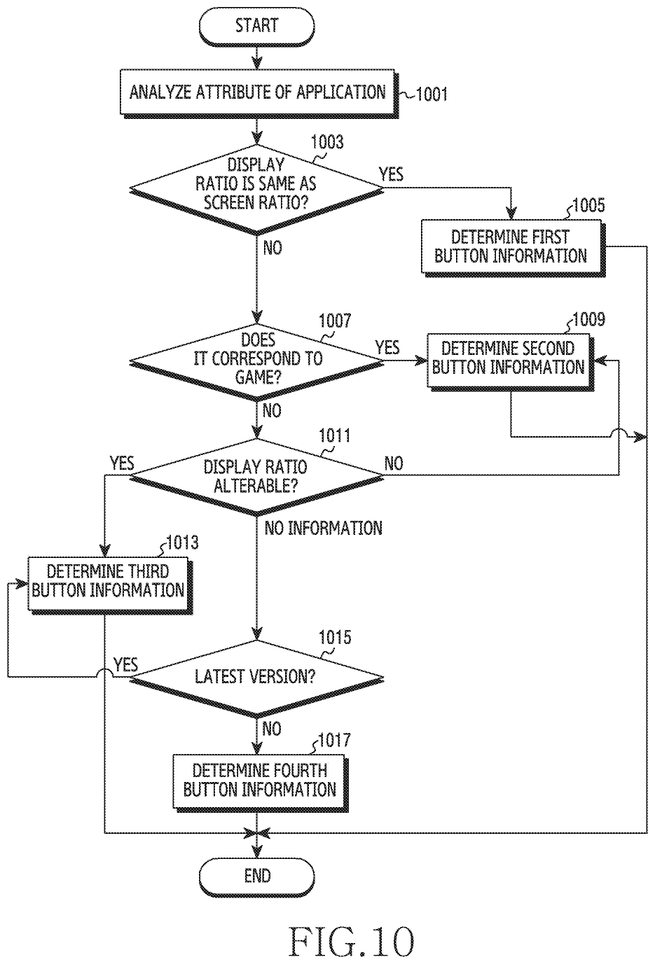

FIG. 10 is a diagram illustrating a method of determining button information for display ratio alteration according to various embodiments.

Referring to FIG. 10, in operation 1001, the electronic device 100 (e.g., the control unit 180) may analyze attribute information of an application. In response to a new application being installed in the electronic device 100 according to a user's request, the control unit 180 may analyze attribute information of the newly installed application.

In operation 1003, the electronic device 100 (e.g., the control unit 18) may determine whether a display ratio of the application is the same as a screen ratio of the electronic device 100, based on the attribute information of the application. For example, the display ratio of the application is configured by a developer who develops the application, and may be set as a ratio optimized to the application. For example, in response to the attribute information of the application being fixed to the screen ratio of the electronic device 100 (e.g., adroid.max_aspect<18.5:9), the control unit 180 may determine that the display ratio of the application is the same as the screen ratio of the electronic device 100.

In response to the display ratio of the application being the same as the screen ratio of the electronic device 100, the control unit 180 may perform operation 1005. In response to the display ratio of the application not being the same as the screen ratio of the electronic device 100, the control unit 180 may perform operation 1007.

In response to the display ratio of the application being the same as the screen ratio of the electronic device 100, in operation 1005, the electronic device 100 (e.g., the control unit 180) may determine first button information correspondingly to the application. For example, the first button information may be for guiding that the display ratio of the application is optimized to the screen ratio of the electronic device 100, and display ratio configuration information cannot be altered. This first button information may be for showing the display ratio configuration information corresponding to the application in a toggle button form. A toggle button of the first button information may be inactivated and displayed as an ‘On’ state wherein the display ratio configuration information cannot be altered. The inactivating may represent that the display ratio of the application cannot be altered even though the first button information is selected.

The toggle button may be an on/off switch. For example, in response to a user input of pressing a button being detected in a button Off state, the control unit 180 may alter the button into ‘On’. In response to the user input of pressing the button being detected in a button On state, the control unit 180 may alter the button into ‘Off’. Here, the button Off state may mean a state of being set to be displayed wherein the display ratio of the application does not correspond to the screen ratio of the electronic device 100. The button On state may mean a state of being set to be displayed wherein the display ratio of the application corresponds to the screen ratio of the electronic device 100.

In response to the display ratio of the application not being the same as the screen ratio of the electronic device 100, in operation 1007, the electronic device 100 (e.g., the control unit 180) may determine whether the attribute information of the application corresponds to a game. In the game, the display ratio of the application is optimized to the application and thus, in response to the display ratio being unreasonably altered, part of an execution screen of the application may be unseen or a dead space may be provided. In response to the attribute information of the application corresponding to a specific attribute (e.g., a game attribute), the control unit 180 may determine that the display ratio of the application cannot be altered into the screen ratio of the electronic device 100.

In response to the attribute information of the application corresponding to the game, the control unit 180 may perform operation 1009. In response to the attribute information of the application not corresponding to the game, the control unit 180 may perform operation 1011.

In response to the attribute information of the application corresponding to the game, in operation 1009, the electronic device 100 (e.g., the control unit 180) may determine second button information correspondingly to the application. For example, the second button information may be for guiding that the display ratio of the application is optimized to the application, and the display ratio configuration information cannot be altered. A toggle button of the second button information may be inactivated and displayed in an ‘Off’ state wherein the display ratio configuration information cannot be altered.

In response to the attribute information of the application not corresponding to the game, in operation 1011, the electronic device 100 (e.g., the control unit 180) may determine whether the display ratio of the application is alterable, based on the attribute information of the application. The display ratio of the application may be configured as a ratio optimized to the application by a developer, but may be permitted to be alterable. In response to being a general application not the specific attribute such as the game, it is possible to display the general application adaptively to the screen ratio of the electronic device 100 by altering a layout of the general application alone, and the dead space may not be provided. In this general application, the alteration of a display ratio of the general application may be permitted.

In response to the display ratio of the application being alterable, the control unit 180 may perform operation 1013. In response to the display ratio of the application being unalterable, the control unit 180 may perform operation 1009. In response to not being able to know whether the display ratio of the application is altered, the control unit 180 may perform operation 1015.

In response to the display ratio of the application being alterable, in operation 1013, the electronic device 100 (e.g., the control unit 180) may determine third button information correspondingly to the application. For example, the third button information may be for guiding that the display ratio of the application is alterable. The third button information may be displayed in an activated state wherein the display ratio configuration information is alterable. For example, a toggle button of the third button information may be ‘On’ as default. The activated state may represent that the display ratio of the application is alterable according to a selection of the third button information.

In response to not being able to know whether the display ratio of the application is altered, in operation 1015, the electronic device 100 (e.g., the control unit 180) may determine whether the application corresponds to the latest OS version, based on the attribute information of the application. The latest OS version may mean that the application is set wherein an operating system of the electronic device 100 is executed at the latest version.

In response to the attribute information of the application corresponding to the latest OS version, the control unit 180 may perform operation 1013. In response to the attribute information of the application not corresponding to the latest OS version, the control unit 180 may perform operation 1017.

In response to the attribute information of the application not corresponding to the latest OS version, in operation 1017, the electronic device 100 (e.g., the control unit 180) may determine fourth button information correspondingly to the application. For example, a toggle button of the fourth button information may be inactivated and displayed in an Off state as default. However, the toggle button of the fourth button information may be alterable into ‘On’ according to user's setting.

FIG. 10 illustrates that after operation 1003 is first performed, operation 1007, operation 1011 and operation 1015 are performed in sequence, but operation 1003, operation 1007, operation 1011, and operation 1015 may be performed concurrently as well, and may be performed in sequence regardless of a sequence illustrated in FIG. 10 as well.

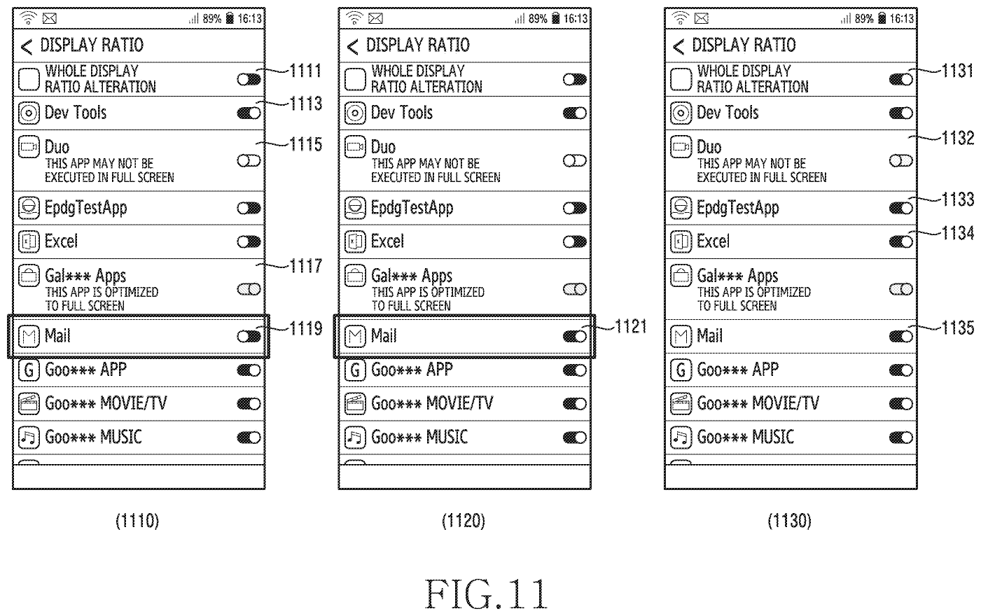

FIG. 11 is a diagram illustrating an example of showing display ratio information of each application according to various embodiments.

Referring to FIG. 11, in response to a display ratio alteration menu being selected, the electronic device 100 (e.g., the control unit 180) may display a first user interface 1110 related with display ratio alteration. The first user interface 1110 may include button information for altering display ratio configuration information of each application. The button information may include the whole button information 1111 for altering collectively (or wholly) the display ratio configuration information of the application, first button information 1113 in which the display ratio configuration information of the application is set as a screen ratio of the electronic device 100, second button information 1115 in which the display ratio configuration information of the application is set as a display ratio of the application, third button information 1117 in which the display ratio configuration information of the application is set as the screen ratio of the electronic device 100, and fourth button information 1119 in which the display ratio configuration information of the application is set as the display ratio of the application. In the first user interface 1110, a toggle button of the whole button information 1111 may be activated and displayed as ‘Off’. In response to the toggle button of the whole button information 1111 being set as ‘Off’, a user may individually alter the display ratio configuration information of each application.

The first button information 1113 and the fourth button information 1119 may alter the display ratio of the application into the screen ratio of the electronic device 100, or alter into a display ratio optimized to the application. A toggle button of the first button information 1113 may be activated and displayed as ‘On’, and a toggle button of the fourth button information 1119 may be activated and displayed as ‘Off’. The activating may represent that the display ratio of the application is alterable by selecting the first button information 1113 or the fourth button information 1119. For example, in response to the toggle button being set as ‘On’, it may be a state in which display ratio configuration information of an application (e.g., Dev Tools) is set as the screen ratio (e.g., about 18.5:9) of the electronic device 100. In response to the toggle button being set as ‘Off’, it may be a state in which display ratio configuration information of an application (e.g., Mail) is set as a display ratio (e.g., about 16:9) of the application.

The second button information 1115 may include a message (e.g., this app cannot be executed in a full screen) of guiding that display ratio configuration information of an application (e.g. Duo) is fixed to the display ratio of the application, and the display ratio configuration information of the application is unalterable. For example, a toggle button of the second button information 1115 may be inactivated and displayed as ‘Off’. The inactivating may represent that a display ratio of the application (e.g., Duo) is unalterable even though the second button information 1115 is selected. In response to the toggle button of the second button information 1115 being selected by a user, the control unit 180 may disregard this. Here, the disregarding may mean that no reaction is made even though the user selects the second button information 1115. Or, in response to the toggle button of the second button information 1115 being selected, the control unit 180 may display an unalterability guide message in the form of a pop-up window. The unalterability guide message displayed in the pop-up window form may be displayed during a specific time (e.g., 3 seconds or 5 seconds). In response to the specific time elapsing, the unalterability guide message may not be displayed (e.g., may be deleted).

The third button information 1117 may include a message (e.g., this app has been optimized to a full screen) of guiding that display ratio configuration information of an application (e.g. Gal*** Apps) is fixed to a screen ratio of the electronic device 100, and the display ratio configuration information of the application is unalterable. For example, a toggle button of the third button information 1117 may be inactivated and displayed as ‘On’. The inactivating may represent that the display ratio of the application (e.g., Gal*** Apps) is unalterable even though the third button information 1117 is selected. In response to the toggle button of the third button information 1117 being selected by the user, the control unit 180 may disregard this. The control unit 180 of various embodiments may differently display a message of guiding that the display ratio configuration information of the application is unalterable, based on the fixed display ratio of the application. For example, in a comparison of the second button information 1115 and the third button information 1117, it may be appreciated that an unalterability guide message of the second button information 1115 is different from an unalterability guide message of the third button information 1117.

In response to the fourth button information 1119 being selected on the first user interface 1110, the electronic device 100 (e.g., the control unit 180) of various embodiments may display a second user interface 1120 in which the setting of fourth button information 1121 is altered. The second user interface 1120 may be that only display ratio configuration information of the fourth button information 1121 is altered in the first user interface 1110. For example, a toggle button of the fourth button information 1119 may be set as ‘Off’ whereas a toggle button of the fourth button information 1121 may be set as ‘On’. In response to the toggle button of the fourth button information 1121 being altered into ‘On’, the control unit 180 may alter the display ratio configuration information of the application (e.g., Mail). For example, in response to the toggle button of the fourth button information 1119 being selected on the first user interface 1110, the control unit 180 may alter the display ratio (e.g., about 16:9) of the application (e.g., Mail) into the screen ratio (e.g., about 18.5:9) of the electronic device 100. Or, in response to the toggle button of the fourth button information 1121 being selected on the second user interface 1120, the control unit 180 may alter the display ratio (e.g., about 18.5:9) set to the application (e.g., Mail) into a display ratio (e.g., about 16:9) of the application.

In response to the whole button information 1111 being selected on the first user interface 1111, the electronic device 100 (e.g., the control unit 180) of various embodiments may display a third user interface 1130 altering display ratio configuration information of the whole application. The third user interface 1130 may be that the display ratio configuration information of the whole application is altered in the first user interface 1110. In the third user interface 1130, a toggle button of the whole button information 1131 may be activated and displayed as ‘On’. In response to the toggle button of the whole button information 1131 being set as ‘On’, the control unit 180 may alter display ratio configuration information of all applications into a screen ratio of the electronic device 100 at one time. Only for an application capable of altering display ratio configuration information, the control unit 180 may alter a display ratio of the application into the screen ratio of the electronic device 100. For example, display ratio configuration information of the application (e.g., Duo) corresponding to first button information 1132 is not able to be altered and thus, may not be altered even in response to the toggle button of the whole button information 1131 being set as ‘On’. Also, the control unit 180 may alter each of toggle buttons of second button information 1133 of an application corresponding to Epdg Test App, third button information 1134 of an application corresponding to Excel, and fourth button information 1135 of an application corresponding to Mail, into ‘On’. The control unit 180 may alter all of display ratio configuration information of the applications corresponding to the second button information 1133, the third button information 1134 and the third button information 1135, into the screen ratio of the electronic device 100.

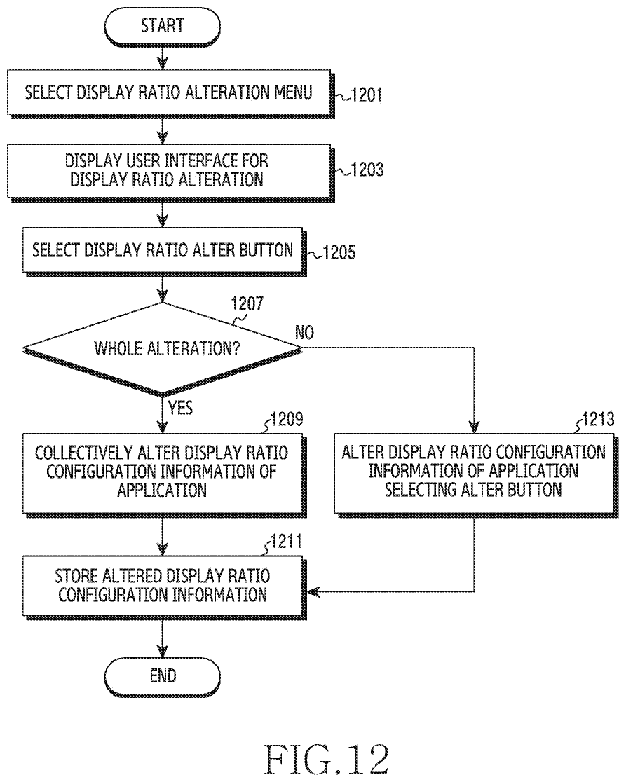

FIG. 12 is a flowchart illustrating an operation for altering a display ratio of each application in an electronic device according to various embodiments.

Referring to FIG. 12, in operation 1201, the electronic device 100 (e.g., the control unit 180) may select a display ratio alteration menu. For example, in response to a user input for altering display ratio configuration information of each application being detected, the control unit 180 may determine that the display ratio alteration menu is selected. The user input may be a preset gesture associated with the selection of the display ratio alteration menu, or may be selecting the display ratio alteration menu from a menu setting item of the electronic device 100.

In operation 1203, the electronic device 100 (e.g., the control unit 180) may display a user interface for display ratio alternation. The user interface may be for managing display ratio configuration information of each application. A user may alter a display ratio of the application individually or alter the display ratio of the application wholly, through the user interface. For example, in response to the display ratio alteration menu being selected, the control unit 180 may display a user interface such as the first user interface 1110, the second user interface 1120, and the third user interface 1130 shown in FIG. 11. The user interface may include application information (e.g., an application name), button information corresponding to the application information, or a ratio alterability/unalterability guide message.

In operation 1205, the electronic device 100 (e.g., the control unit 180) may receive a selection of a display ratio alter button. The display ratio alter button may include button information capable of individually managing the display ratio of the application, or whole button information capable of wholly managing the display ratio of the application. The user may select individual button information displayed on a per-application basis, or may select the whole button information capable of wholly managing the display ratio of the application.

In operation 1207, the electronic device 100 (e.g., the control unit 180) may determine whether the selected display ratio alter button is whole alteration.

In response to being the whole alteration, the control unit 180 may perform operation 1209. In response to not being the whole alteration, the control unit 180 may perform operation 1213.

In response to not being the whole alteration, in operation 1213, the electronic device 100 (e.g., the control unit 180) may alter display ratio configuration information of an application for which the alter button is selected. For example, in a description referring to FIG. 11, in response to the first user interface 1110 being displayed in operation 1203, and the fourth button information 1119 being selected in operation 1205, the control unit 180 may alter display ratio configuration information of an application (e.g., Mail) corresponding to the fourth button information 1119. The control unit 180 may alter the display ratio of the application into the screen ratio of the electronic device 100. After performing operation 1213, the control unit 180 may perform operation 1211.

In response to being the whole alteration, in operation 1209, the electronic device 100 (e.g., the control unit 180) may collectively alter the display ratio configuration information of the application. For example, in a description referring to FIG. 11, in response to the first user interface 1110 being displayed in operation 1203, and the whole button information 1111 being selected in operation 1205, the control unit 180 may alter display ratio configuration information of all applications. The control unit 180 may alter display ratios of all the applications into the screen ratio of the electronic device 100. At this time, only for an application capable of altering display ratio configuration information, the control unit 180 may alter a display ratio of the application into the screen ratio of the electronic device 100.

In operation 1211, the electronic device 100 (e.g., the control unit 180) may store the altered display ratio configuration information. For example, the control unit 180 may store the display ratio configuration information of altered one application in the memory 150, or store display ratio configuration information of collectively altered one or more applications in the memory 150. For example, in a description referring to FIG. 11, in response to display ratio configuration information of an application (e.g., Mail) corresponding to the fourth button information 1119 being altered in operation 1213, the control unit 180 may store the display ratio configuration information of the altered application (e.g., Mail) in the memory 150, and display the second user interface 1120 in which the display ratio configuration information of the fourth button information 1119 is altered. Or, in a description referring to FIG. 11, in response to display ratio configuration information of the whole application being altered correspondingly to the whole button information 1111 in operation 1209, the control unit 180 may store the display ratio configuration information of the altered application in the memory 150, and display the third user interface 1130 in which the display ratio configuration information of the whole application is altered.

An operation method of an electronic device of various embodiments may include displaying an execution screen of an application, detecting a user input of selecting a menu item, confirming display ratio configuration information of the displayed application, displaying a button for altering a display ratio of the application onto an application card on a list of recently executed applications, based on the confirmed display ratio configuration information, and altering the display ratio of the application according to a selection of the displayed button.

The altering may include altering and displaying a layout of the application, based on the altered display ratio configuration information.

The displaying of the button may include, in response to the display ratio configuration information being a first configuration, generating a first button, and in response to the display ratio configuration information being a second configuration, generating a second button.

The displaying of the button may further include, in response to detecting a gesture of calling a notification list while the execution screen of the application is displayed, displaying a new user interface including the button for altering the display ratio of the application.

The displaying of the button may further include displaying, together, the button for altering the display ratio of the application on the execution screen of the application.

The displaying of the button may further include, in response to detecting a preset gesture on the execution screen of the displayed application, determining whether the display ratio of the application is alterable, based on the preset gesture and the display ratio configuration information of the application, and in response to the display ratio of the application being alterable, displaying the button.

The method may further include generating button information corresponding to the application, based on attribute information of the application.

The button information may include at least one of first button information in which the display ratio of the application is fixed to a screen ratio of the electronic device, second button information in which the display ratio of the application is fixed to the application, or third button information indicating that the display ratio of the application is alterable.

And, embodiments disclosed in the specification and drawings are to only suggest specific examples so as to easily explain the substance of the disclosure and help understanding, and do not intend to limit the scope of the disclosure. Accordingly, the scope of the disclosure should be construed as including all modified or changed forms that are drawn on the basis of the technological spirit of the disclosure, besides the embodiments disclosed herein.

1. An electronic device comprising:
a memory;
a display; and
a processor operatively connected to the memory or the display,
wherein the processor is configured to:
in response to detecting a user input of selecting a menu item while an execution screen of an application is displayed on the display, confirm display ratio configuration information, stored in the memory, of the application,
display a button for altering a display ratio of the application onto an application card on a list of recently executed applications, based on the confirmed display ratio configuration information, and
alter the display ratio of the application according to a selection of the displayed button.

2. The electronic device of claim 1, wherein the processor is further configured to:
alter and display a layout of the application, based on the altered display ratio configuration information.

3. The electronic device of claim 1, wherein the processor is further configured to, in response to detecting a gesture of calling a notification list while the execution screen of the application is displayed, display a new user interface comprising the button for altering the display ratio of the application.

4. The electronic device of claim 1, wherein the processor is further configured to display, together, the button for altering the display ratio of the application on the execution screen of the application.

5. The electronic device of claim 4, wherein the processor is further configured to:
in response to the button being selected on an execution screen of the application displayed at a first display ratio, alter the display ratio of the application into a second display ratio; and
in response to the button being selected on an execution screen of the application displayed at the second display ratio, alter the display ratio of the application into the first display ratio.

6. The electronic device of claim 4, wherein the processor is further configured to:
in response to receiving an application execution request, determine whether the display ratio of the application is alterable; and
in response to the display ratio of the application being alterable, display the button for altering the display ratio of the application on the execution screen of the application.

7. The electronic device of claim 1, wherein the processor is further configured to, in response to detecting a preset gesture on the execution screen of the displayed application, determine whether the display ratio of the application is alterable, based on the preset gesture and the display ratio configuration information of the application.

8. The electronic device of claim 7, wherein the processor is further configured to, in response to detecting a first preset gesture on the execution screen of the application displayed at the first display ratio or a second preset gesture on the execution screen of the application displayed at the second display ratio, determine whether the display ratio of the application is alterable.

9. The electronic device of claim 1, wherein the processor is further configured to generate button information corresponding to the application, based on attribute information of the application.

10. An operation method of an electronic device, the method comprising:
displaying an execution screen of an application;
detecting a user input of selecting a menu item;
confirming display ratio configuration information of the displayed application;
displaying a button for altering a display ratio of the application onto an application card on a list of recently executed applications, based on the confirmed display ratio configuration information; and
altering the display ratio of the application according to a selection of the displayed button.

11. The method of claim 10, wherein the altering comprises:
altering and displaying a layout of the application, based on the altered display ratio configuration information.

12. The method of claim 10, wherein the displaying of the button further comprises, in response to detecting a gesture of calling a notification list while the execution screen of the application is displayed, displaying a new user interface comprising the button for altering the display ratio of the application.

13. The method of claim 10, wherein the displaying of the button further comprises displaying, together, the button for altering the display ratio of the application on the execution screen of the application.

14. The method of claim 10, wherein the displaying of the button further comprises:
in response to detecting a preset gesture on the execution screen of the displayed application, determining whether the display ratio of the application is alterable, based on the preset gesture and the display ratio configuration information of the application; and
in response to the display ratio of the application being alterable, displaying the button.

15. The method of claim 10, further comprising generating button information corresponding to the application, based on attribute information of the application.

16. The electronic device of claim 1, wherein the processor is further configured to:
in response to the display ratio configuration information being a first configuration, generate a first button, and
in response to the display ratio configuration information being a second configuration, generate a second button.

17. The electronic device of claim 9, wherein the button information comprises at least one of:
first button information in which the display ratio of the application is fixed to a screen ratio of the electronic device,
second button information in which the display ratio of the application is fixed to the application, or
third button information indicating that the display ratio of the application is alterable.

18. The method of claim 10, wherein the displaying of the button comprises:
in response to the display ratio configuration information being a first configuration, providing a first button; and
in response to the display ratio configuration information being a second configuration, providing a second button.

19. The method of claim 15, wherein the button information comprises at least one of:
first button information in which the display ratio of the application is fixed to a screen ratio of the electronic device,
second button information in which the display ratio of the application is fixed to the application, or
third button information indicating that the display ratio of the application is alterable.

20. A non-transitory computer-readable recording medium storing a program for executing instructions, the instructions comprising:
displaying an execution screen of an application;
detecting a user input of selecting a menu item;
confirming display ratio configuration information of the displayed application;
displaying a button for altering a display ratio of the application on the basis of the confirmed display ratio configuration information, onto an application card on a list of recently executed applications; and
altering the display ratio of the application according to a selection of the displayed button.
